(19) United States
(12) Patent Application Publication
(10) Pub. No.: US 2026/0271921 A1
(43) Pub. Date: Sep. 17, 2026

(54) DILUTION-INDUCED RELEASE COMPOSITIONS AND METHODS OF USE THEREOF

(71) Applicant: Board of Supervisors of Louisiana State University and Agricultural and Mechanical College, Baton Rouge, LA (US)

(72) Inventors: Amy Xu, Baton Rouge, LA (US); Sulochana E. Mudiyanselage, Baton Rouge, LA (US)

(21) Appl. No.: 19/568,388

(22) Filed: Mar. 16, 2026

Related U.S. Application Data
(60) Provisional application No. 63/772,142, filed on Mar. 14, 2025.

(51) Int. Cl. A01N 25/30; A01N 25/04; A01N 25/24

(52) U.S. Cl. CPC A01N 25/30; A01N 25/04; A01N 25/24

(57) ABSTRACT

Aspects of the disclosure described herein are drawn toward dilution-induced release compositions, methods of forming, and methods of use thereof. The dilution-induced release compositions of the disclosure can be used to increase the wettability of a surface. Further, the increased wettability of a surface can be used to deliver a payload compound. The dilution-induced release composition of the disclosure can be formed from a combination of mixed surfactant micelles and polymer solutions.

This application claims priority to U.S. Provisional Application No. 63/772,142 filed on Mar. 14, 2025, the entire contents of which are incorporated herein by reference.

All patents, patent applications, and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

### GOVERNMENT INTERESTS

This invention was made with government support under grant AM211099 awarded by the United States Department of Agriculture. The government has certain rights in the invention.

This patent disclosure contains material that is subject to copyright protection. The copyright owner has no objection to the facsimile reproduction by anyone of the patent document or the patent disclosure as it appears in the U.S. Patent and Trademark Office patent file or records but otherwise reserves any and all copyright rights.

### FIELD OF THE INVENTION

The present invention relates to dilution induced release compositions, micelle-polymer complex coacervates, and methods of use thereof.

### BACKGROUND

Detailed Plant surfaces can be superhydrophobic, creating challenges for agricultural products such as sprays and coatings, which are often water-based. These products can bounce off or fail to adhere properly to the plant surfaces, reducing their effectiveness. The coacervate complexes we have developed demonstrate superior wetting and adhesion on superhydrophobic surfaces, making them valuable for improving the delivery, retention, and effectiveness of agricultural products.

### SUMMARY OF THE INVENTION

Aspects of the disclosure are drawn towards a dilution-induced release composition comprising: a mixed surfactant micelle, wherein the mixed surfactant micelle comprises an anionic surfactant and a non-ionic surfactant in a mole fraction (Y) of about 0.20 to about 0.60; a cationic polyelectrolyte; a payload; and an isoionic diluent. In embodiments, the anionic surfactant is selected from one or more of an alkyl sulfate, an alkyl ether sulfate, an alkylbenzene sulfonate, or a sulfosuccinate. In embodiments, the non-ionic surfactant is selected from one or more of a fatty alcohol ethoxylate, an alkylphenol ethoxylate, a fatty acid ethoxylate, or an alcohol alkoxylates. In embodiments, the payload is selected from a hydrophobic compound or a hydrophilic compound. In embodiments, the hydrophobic compound comprises a fungicide, a pesticide, or an herbicide, wherein the partition coefficient (log P) is about 3.0 to about 7.0. In embodiments, the hydrophilic compound comprises a fungicide, a pesticide, or an herbicide, wherein the partition coefficient (log P) is about-4.5 to about 3.0. In embodiments, the hydrophobic compound is selected from permethrin, cypermethrin, deltamethrin, tebuconazole, or azoxystrobin. In embodiments, the hydrophilic compound is selected from azoxystrobin, atrazine, paraquat, or diquat. In embodiments, the alkyl sulfate is sodium dodecyl sulfate (SDS). In embodiments, the fatty-alcohol ethoxylate is selected from one or more of: lauryl myristyl alcohol ethoxylate of the formula:

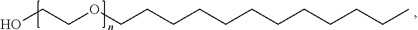

wherein n=6-7, or octylphenol ethoxylate of the formula:

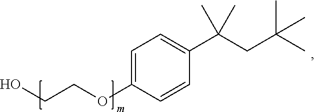

wherein m=9-10. In embodiments, the cationic polyelectrolyte is selected from one or more of a poly(diallyldimethylammonium chloride) (PDADMAC), a poly(ethyleneimine) (PEI), a chitosan, a poly(allylamine), a poly(vinylamine), a poly(N-alkyl 4-vinyl pyridinium), a poly(N-alkyl 2-vinyl pyridinium), a poly([2-(acryloyloxy)ethyl]trimethylammonium), a poly(N,N-dimethyl-3,5-dimethylene piperidinium chloride), or a poly(vinylbenzyltrimethylammonium chloride) (PVBTMACl). In embodiments, the cationic polyelectrolyte is poly(diallyldimethylammonium chloride) (PDADMAC) with an Mw of about 100 kDa to about 500 kDa. In embodiments, the cationic polyelectrolyte is present in a concentration of about 0.5 mg/mL to about 30.0 mg/mL. In embodiments, the iso-ionic diluent is a sodium chloride (NaCl) solution. In embodiments, the NaCl solution is present in a concentration of about 300 mM to about 500 mM. In embodiments, the composition is a coating, an adhesive, a surface modifier, an interfacial spreading mediator, a drug delivery system, or an anti-fouling agent. In embodiments, the weight ratio of the cationic polyelectrolyte in relation to the total amount of mixed surfactant micelle (W) comprises about 0.10 to about 0.90. In embodiments, the critical level total macromolecular concentration (Cₜ′) comprises about 10.0 mM to about 150 mM. In embodiments, the payload is present in a concentration of about 0.05 mM to about 10 mM. In embodiments, the composition exhibits a contact angle of: about 7° to about 25° on a hydrophilic surface and about 5° to about 25° on a hydrophobic surface. In embodiments, the anionic surfactant is sodium dodecyl sulfate present in about 1.5 mM to about 4.3 mM. In embodiments, the non-ionic surfactant is lauryl myristyl alcohol ethoxylate present in about 4.0 mM to about 6.5 mM. In embodiments, the polycationic electrolyte is poly(diallyldimethylammonium chloride) (PDADMAC) present in about 1.25 mg/mL to about 3.25 mg/mL.

Aspects of the disclosure are drawn towards a method of forming a dilution-induced release composition, the method comprising: providing a solution containing a cationic polyelectrolyte, a mixed surfactant micelle, and an iso-ionic diluent, wherein the cationic polyelectrolyte solution comprises a cationic polyelectrolyte dissolved in a solution, and wherein the mixed surfactant micelle comprises a non-ionic surfactant and an anionic surfactant in a molar fraction (Y) of about 0.05 to about 0.7; and adding a payload compound to the solution, wherein the payload compound is selected from a hydrophobic compound or a hydrophilic compound, thereby forming a dilution-induced release composition. In embodiments, the non-ionic surfactant is selected from a fatty alcohol ethoxylate, alkylphenol ethoxylates, fatty acid ethoxylates, alcohol alkoxylates, or any combination thereof. In embodiments, the anionic surfactant is selected from an alkyl sulfate, an alkyl ether sulfate, an alkylbenzene sulfonate, a sulfosuccinate, or a combination thereof. In embodiments, the cationic polyelectrolyte is selected from poly(diallyldimethylammonium chloride) (PDADMAC), poly(ethyleneimine) (PEI), a chitosan, poly(allylamine), poly(vinylamine), poly(N-alkyl 4-vinyl pyridinium), poly(N-alkyl 2-vinyl pyridinium), poly([2-(Acryloyloxy)ethyl]trimethylammonium), Poly(N,N-dimethyl-3,5-dimethylene piperidinium chloride), poly(vinylbenzyltrimethylammonium chloride) (PVBTMACl), or a combination thereof. In embodiments, the hydrophobic payload compound comprises a fungicide, a pesticide, or an herbicide, wherein the partition coefficient (log P) is about 3.0 to about 7.0. In embodiments, the hydrophilic payload compound comprises a fungicide, a pesticide, or an herbicide, wherein the partition coefficient (log P) is about −4.5 to about 3.0. In embodiments, the iso-ionic diluent comprises a sodium chloride (NaCl) solution. In embodiments, the cationic polyelectrolyte and total amount of surfactant comprise a weight ratio (W) of about 0.01 to about 0.90. In embodiments, the critical level total macromolecular concentration (Cₜ′) comprises about 1.0 mM to about 150 mM. In embodiments, the iso-ionic diluent is present in a concentration of about 100 mM to about 700 mM.

Aspects of the disclosure are drawn towards a method of delivering a payload to a surface, the method comprising; administering a dilution-induced release composition comprising a payload to a surface, wherein the dilution-induced release composition comprises the composition of any one of the compositions described herein and applying a diluent to the dilution-induced release composition comprising a payload, thereby delivering a payload to a surface. In embodiments, the administering comprises spraying, layer-by-layer self-assembly, drop casting, spread coating, or a combination thereof; the applying a diluent comprises diluting the dilution-induced release composition comprising a payload until the critical total macromolecular concentration (C_{T}′) is reached; the surface of interest comprises a superhydrophobic plant leaf, a rough hydrophobic surface, a plant bark surface, a textile, a printing surface, or a microfluidic device surface; and the diluent comprises an aqueous liquid.

### BRIEF DESCRIPTION OF THE FIGURES

FIG. 1 shows a non-limiting, exemplary schematic illustration of the two wetting states on patterned surfaces.

FIG. 2 shows non-limiting, exemplary graphs showing turbidimetric type 1 titration for the SDS/LA65N-PDADMAC system. The figure is shaded to highlight the different phase transitions the system undergoes. In particular, the middle region marks the course of complex coacervation (0.23<Y<0.34), while the right region indicates the precipitation phase observed at higher Y values (Y>0.34).

FIG. 3 shows non-limiting, exemplary Rh and ζ-potential measured from SDS/LA65N micelles prepared at various Y values.

FIG. 4 shows non-limiting exemplary phase boundaries of the SDS/LA65N-PDADMAC system. Data points are color-coded to distinguish micelles prepared at different Y values. Dotted lines represent polynomial fits to the experimental data, and the area beneath the curves indicates the coacervation region.

FIG. 5A shows a non-limiting, exemplary SANS profile measured from SDS/LA65N micelles prepared at various Y values. The datasets are offset by a factor of 2 for better visual clarity. The inset demonstrates the SANS model fitting to the profile measured from Y=0.25 micelles, where experimental data are shown as spheres and the fit is represented by the solid line.

FIG. 5B shows non-limiting, exemplary fitting parameters extracted from the model fits for contour length (Å) of micelles prepared at different Y values.

FIG. 5C shows non-limiting, exemplary fitting parameters extracted from the model fits for radius (Å) of micelles prepared at different Y values.

FIG. 6 shows a non-limiting, exemplary schematic illustration of the structure of SDS and LA65N surfactant molecules as well as their arrangements when forming micelles at low Y (left) and high Y (right) values.

FIG. 7A shows a non-limiting, exemplary image of complex coacervates in a glass tube. Micelles were labeled with methylene blue, making coacervates which are rich in micelles also appear blue. This coloring enhances the visibility of coacervates, which would otherwise be transparent, allowing for better visualization in the image.

FIG. 7B shows a non-limiting, exemplary image of complex coacervates in a polypropylene tube. Micelles were labeled with methylene blue, making coacervates which are rich in micelles also appear blue. This coloring enhances the visibility of coacervates, which would otherwise be transparent, allowing for better visualization in the image.

FIG. 8 shows a non-limiting, exemplary image of an SEM image taken from methyltrichlorosilane-coated surface.

FIG. 9A shows a non-limiting, exemplary Turbidimetric Type 2 titration curve for the SDS/LA65N-PDADMAC system. Shaded areas highlight the region where complex coacervates are formed: left shaded region for coacervates, middle shaded section for gels, and right shaded section for precipitates.

FIG. 9B shows a non-limiting, exemplary graph of contact angle measurements of SDS/LA65N-PDADMAC samples deposited on hydrophilic and hydrophobic surfaces. Contact angles from micelle-only solutions are shown as flat lines to illustrate their spreading behavior on both surface types, with the bottom line representing hydrophilic and the upper line representing hydrophobic surfaces. Dotted lines indicate measurements from samples containing micelle/polymer complexes to highlight the overall trend across the titrations. Shaded regions mark the distinct phases observed during titration: left shaded region for coacervates, middle shaded section for gels, and right shaded section for precipitates.

FIG. 10 shows a non-limiting, exemplary schematic illustration of surfactant deposition at the solid-liquid interface: micelle-only deposition (top) and coacervate-assisted deposition (bottom). SDS molecules are shown with red-colored headgroups, while non-ionic LA65N molecules are depicted with gray-colored headgroups. PDADMAC polymers are represented as black curly lines.

FIG. 11 shows non-limiting, exemplary images collected during the Type 2 titration of SDS/LA65N micelles into PDADMAC solution. Each image is labeled with a circle at the top-left corner, indicating the phase observed at that titration stage. The codes represent distinct phases: SC (soluble complexes), CC (complex coacervates), GP (gel-like phase), and P (precipitates).

FIG. 12 shows non-limiting, exemplary bright-field (left column) and fluorescence (right column) microscopic images taken from SDS/LA65N-PDADMAC complexes at different phases, including coacervate phase (a and b), gel phase (c and d) and precipitate phase (e and f).

FIG. 13 shows non-limiting, exemplary images of contact angle measurements for water and micelle solution deposited on hydrophilic (top) and hydrophobic (bottom) surfaces.

FIG. 14 shows non-limiting, exemplary SANS profiles measured from SDS/LA65N micelle (circle), PDADMAC (square) solutions and their complex coacervate (triangle) prepared in D2O contrast.

FIG. 15 shows a non-limiting, exemplary diagram of a process for making complex coacervates.

FIG. 16 shows a non-limiting, exemplary graph and images indicating phase boundary of Y=0.3 SDS/LA60-PDADMAC coacervate system in 0.4M NaCl.

FIG. 17A shows a non-limiting, exemplary image of SEM imaging and contact angle measurement of MTC-SHPB surface.

FIG. 17B shows a non-limiting, exemplary image of SEM imaging and contact angle measurement of MTC-SHPB surface at 20,000×.

FIG. 17C shows a non-limiting, exemplary image of contact angle measurement of a water drop on MTC-SHPB surface.

FIG. 18A shows a non-limiting, exemplary SEM image of a PMMA-HPB surface at 1000×.

FIG. 18B shows a non-limiting, exemplary SEM image of a PMMA-HPB surface 20,000×.

FIG. 18C shows a non-limiting, exemplary image of contact angle measurement of a water drop on a PMMA-HPB surface.

FIG. 19A shows a non-limiting, exemplary SEM image of an ODTC-HPB surface at 1000×,

FIG. 19B shows a non-limiting, exemplary SEM image of an ODTC-HPB surface at 20,000×.

FIG. 19C shows a non-limiting, exemplary image of a contact angle measurement of a water drop on ODTC-HPB surface.

FIG. 20 shows a non-limiting, exemplary image of contact angle measurement of a water drop on hydrophilic glass surface.

FIG. 21 shows non-limiting, exemplary contact angle changes upon dilution of suppressed phase. More dilution causes more complex coacervate formation where decrement in contact angle was observed on Hydrophilic Surface

FIG. 22 shows non-limiting, exemplary changes in contact angles upon systematic dilution of suppressed phase on different surfaces.

FIG. 23A shows non-limiting, exemplary light and fluorescence microscopic images (×2) of Y=0.45 SDS/LA60-PDADMAC coacervate droplet deposition on a Hydrophilic Surface.

FIG. 23B shows non-limiting, exemplary light and fluorescence microscopic images (×2) of Y=0.45 SDS/LA60-PDADMAC coacervate droplet deposition on a MTC-SHPB Surface.

FIG. 23C shows non-limiting, exemplary light and fluorescence microscopic images (×2) of Y=0.45 SDS/LA60-PDADMAC coacervate droplet deposition on a ODTC-HPB Surface.

FIG. 24A-24C show non-limiting, exemplary images of complex coacervates.

FIG. 25 shows a non-limiting, exemplary graph of phase boundaries for complex coacervates with an image of a complex coacervate wrapped around a Teflon stir bad and an image of a suppressed system in a glass test tube.

FIG. 26 shows a non-limiting, exemplary illustration of a Type 1 Turbidimetric Titration of SDS into a PDADMAC/LA65N system.

FIG. 27 shows a non-limiting, exemplary image of complex coacervates wrapped around a Teflon stir bar.

FIG. 28 shows non-limiting, exemplary images of contact angle measurements of water, micelle, and coacervate on both hydrophilic and hydrophobic surfaces.

FIG. 29 shows a non-limiting, exemplary image illustrating the wetting behavior of a water droplet (left) and a complex coacervate (right) on a piece of tree bark.

FIG. 30 shows a non-limiting, exemplary fluorescence image Nile Red dye molecules incorporated into the micelle fraction of a coacervate matrix under an embodiment. Y=0.4 micelles were loaded with Nile red and it was mixed with 1.5 g/L PDADMAC to form coacervates. The coacervates were visualized under the fluorescence microscope.

FIG. 31 shows a non-limiting, exemplary fluorescence image showing the encapsulation of Rhodamin-B dye molecules under an embodiment. Rhodamine B has an excitation energy of 540-570 nm and an emission energy of 565-595 nm.

FIG. 32 shows a non-limiting, exemplary fluorescence image of the cationic dye ThT bound in a coacervate under an embodiment.

FIG. 33 shows non-limiting, exemplary fluorescence imaging of DICC: suppressed phase and NaCl dilutions of 200 μL, 500 μL, 800 μL, 1000 μL, 1200 μL on a hydrophilic surface (row A) and on a MTC-SHPB surface (row B).

### DETAILED DESCRIPTION OF THE INVENTION

Detailed descriptions of one or more embodiments are provided herein. It is to be understood, however, that the invention can be embodied in various forms. Therefore, specific details disclosed herein are not to be interpreted as limiting, but rather as a basis for the claims and as a representative basis for teaching one skilled in the art to employ the invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). In embodiments, the term “about” can be denoted by “~”.

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure can be used for other embodiments or of being practiced or carried out in various ways. Other compositions, compounds, methods, features, and advantages of the disclosure will be or become apparent to one having ordinary skill in the art upon examination of the following drawings, detailed description, and examples. All such additional compositions, compounds, methods, features, and advantages can be included within this description, and be within the scope of the disclosure.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C1-C30 for straight chains, C3-C30 for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein can refer to an alkyl group, as defined herein, but having from one to ten carbons, or from one to six carbon atoms in its backbone structure. Likewise, “lower alkenyl” and “lower alkynyl” have similar chain lengths. In some embodiments, alkyl groups are lower alkyls. In some embodiments, a substituent described herein as alkyl can be a lower alkyl.

It will be understood by those skilled in the art that the moieties substituted on the hydrocarbon chain can themselves be substituted, if appropriate. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF3, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined herein for alkyl groups.

The term “alkylthio” refers to an alkyl group, as defined herein, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined herein for alkyl groups.

The terms “alkenyl” and “alkynyl”, refer to unsaturated aliphatic groups analogous in length and possible substitution to the alkyls described herein, but that contain at least one double or triple bond respectively. For example,

The terms “alkoxyl” or “alkoxy” as used herein refers to an alkyl group, as defined herein, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined herein. The alkoxy and aroxy groups can be substituted as described herein for alkyl.

The terms “amine” and “amino” are art-recognized and refer to both unsubstituted and substituted amines, e.g., a moiety that can be represented by the general formula:

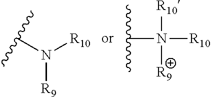

wherein R₉, R₁₀, and R_{10′} each independently represent a hydrogen, an alkyl, an alkenyl, —(CH₂)ₘ— Rs or R₉ and R₁₀ taken together with the N atom to which they are attached complete a heterocycle having from 4 to 8 atoms in the ring structure; Rs represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R_{10′}) each independently represent a hydrogen, an alkyl or cycloalkyl, an alkenyl or cycloalkenyl, or alkynyl. Thus, the term “alkylamine” as used herein can refer to an amine group, as defined herein, having a substituted (as described herein for alkyl) or unsubstituted alkyl attached thereto, i.e., at least one of R₉ and R₁₀ is an alkyl group.

As used herein, the term “imide” can refer to —C(O)NR′R″, wherein R′ and R″ are each independently hydrogen, or a substituted or unsubstituted alkyl, cycloalkyl, alkenyl, alkynyl, aryl aralkyl, heterocyclyl or heterocyclylalkyl group as defined herein.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

The term “substituted” as used herein, refers to permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, amino acid, peptide, and polypeptide groups. As used herein in reference to an “R” group, the name used to describe said “R” group can be the chemical name prior to the removal of a hydrogen. For example, wherein “R” is described as an “alkane” can refer to an “alkyl” group.

Heteroatoms such as nitrogen can have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

In embodiments, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen can have hydrogen substituents and/or any permissible substituents of organic compounds described herein which satisfy the valencies of the heteroatoms.

In various aspects, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

Aspects of the disclosure are drawn towards a dilution induced release composition. In embodiments, the composition comprises a mixed surfactant micelle, a cationic polyelectrolyte, a payload, and an isoionic diluent. In embodiments, the mixed surfactant micelle comprises a non-ionic surfactant and an anionic surfactant in a mole fraction (Y) of about 0.20 to about 0.60. In embodiments, the mole fraction (Y) can be about 0.30 to about 0.50. In certain embodiments, the mole fraction (Y) is 0.30.

As described herein, and exemplified in the examples, the mixed surfactant micelle, cationic polyelectrolyre, and iso-ionic diluent can form complex coacervates. The formation of a coacervate can be used to deliver a payload.

Described herein are payloads that can be carried by, bound to, or encapsulated in any embodiment of the dilution-induced release composition of this disclosure. A payload can be a compound. The compound described herein can be an agrochemical including but not limited to a herbicide, a pesticide, or a fungicide.

In embodiments, the payload can be a hydrophobic compound including but not limited to a hydrophobic pesticide, a hydrophobic herbicide, or a hydrophobic fungicide. In embodiments, the payload can be a hydrophilic compound including but not limited to a hydrophilic pesticide, a hydrophilic herbicide, or a hydrophilic fungicide. The hydrophobic compounds described herein can have a partition coefficient, referred to herein as log P, of about 3.0 to about 7.0. The hydrophilic compounds described herein can have a log P of about-4.5 to about 3.0. As used herein, partition coefficient refers to the quantification of how a substance interacts between a nonpolar organic phase and a polar aqueous phase, and is a term well understood by one of ordinary skill in the art. Commonly the partition coefficient is measured with respect to n-octanol and water, which can be measured using the shake-flask method as outlined by OECD test 107 [OECD (1995), Test No. 107: Partition Coefficient (n-octanol/water): Shake Flask Method, OECD Guidelines for the Testing of Chemicals, Section 1, OECD Publishing].

As such, for example, the hydrophobic pesticide can be permethrin, cypermethrin, or deltamethrin. Further, for example, the hydrophobic fungicide can be azoxystrobin or tebuconazole. In some embodiments, for example, the hydrophilic herbicide can be paraquat, diquat, or atrazine.

As described herein the payload, hydrophilic or hydrophobic, can have a molecular weight of about 1000 Da or less. In some embodiments the payload compound can have a molecular weight greater than 1000 Da. In some embodiments, the payload can have a molecular weight of about 600 Da or less. In embodiments, the molecular weight for the hydrophobic payload compound or the hydrophilic payload compound can have a molecular weight of about 100 Da to about 500 Da. In some further embodiments, the molecular weight for the hydrophobic agrochemical payload or the hydrophilic agrochemical payload can be about 200 Da to about 400 Da. The payload compound described herein, that can be carried in or loaded on to the coacervate described herein, can have a size limited by the hydrodynamic radius of the payload compound. However, payloads of greater than 1000 Da can also be used by adjusting parameters such as concentration as known in the art.

In some non-limiting, exemplary embodiments, the hydrophobic payload compound can be selected from permethrin having a log P value of 6.1 to 6.5 and a molecular weight of 391.29 Da, cypermethrin having a log P value of 6.22 and a molecular weight of 416.30 Da, deltamethrin having a log P value of 6.20 and a molecular weight of 505.20 Da, tebuconazole having a log P value of 3.7 and a molecular weight of 307.82 Da, or azoxystrobin having a log P value of about 2.5 to about 5.13 and a molecular weight of 403.39 Da. In some non-limiting, exemplary embodiments, the hydrophilic payload compound can be selected from azoxystrobin having a log P value of about 2.5 to about 5.13 and a molecular weight of 403.39 Da, atrazine having a log P value of 2.59 and a molecular weight of 215.69 Da, paraquat having a log P value of −4.5 and a molecular weight of 257.16 Da, or diquat having a log P value of −4.6 and a molecular weight of 184.1 Da.

In embodiments, the payload compound can be present in a concentration of about 0.05 mM to about 10 mM. In some embodiments, the payload compound can be present in a concentration of about 0.1 mM to about 5 mM. In some embodiments, the payload compound can be present in a concentration of about 1 mM to about 10 mM. In some embodiments, the payload compound can be present in a concentration of about 0.1 mM to about 1.0 mM. For example, the payload compound can be present in a concentration of about 0.05 mM, about 0.075 mM, about 0.1 mM, about 0.125 mM, about 0.15 mM, about 0.175 mM, about 0.2 mM, about 0.3 mM, about 0.4 mM, about 0.5 mM, about 0.75 mM, about 1.0 mM, about 1.5 mM, about 2.0 mM, about 2.5 mM, about 3.0 mM, about 3.5 mM, about 4.0 mM, about 4.5 mM, about 5.0 mM, about 5.5 mM, about 6.0 mM, about 6.5 mM, about 7.0 mM, about 7.5 mM, about 8.0 mM, about 8.5 mM, about 9.0 mM, about 9.5 mM, or about 10 mM.

The compositions described herein have network structures which can encapsulate hydrophobic and hydrophilic substances based on their structure and act as a delivery agent. Not only do these surfactant-based complex coacervates have a network structure, but they can also lower the surface tension and promote wetting. The network structure of the coacervates entangle with the nano and microstructures on the rough hydrophobic surface as well as facilitate the coordinated delivery of micelles onto the surface, promoting better spreading and retention/adhesivity.

As demonstrated in the Examples presented herein, the mechanism of encapsulation in the dilution induced release composition of this disclosure can vary depending on the nature of the payload of interest. In embodiments, using a hydrophobic payload, the payload can diffuse into the micelle of the composition described herein. In some embodiments, when using a hydrophilic or charged payload, the payload can bind or interact with the anionic surfactant component of the composition described herein.

In some embodiments, the anionic surfactant can be selected from one or more of an alkyl sulfate, an alkyl ether sulfate, and alkylbenzene sulfonate, a sulfosuccinate, or a combination there of. For example, the anionic surfactant can be sodium dodecyl sulfate (SDS):

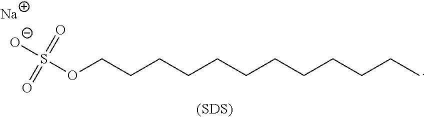

Anionic surfactants described herein, can include, but are not limited to sodium dodecyl sulfate (SDS), ammonium lauryl sulfate (ALS), sodium laureth sulfate (SLES), sodium myreth sulfate, sodium cetyl sulfate, sodium octyl sulfate, sodium decyl sulfate, triethanolamine lauryl sulfate, secondary alkyl sulfates, linear alkylbenzene sulfonate (LAS), alpha olefin sulfonate (AOS), sodium dodecylbenzene sulfonate (SDBS), sodium stearate, potassium cocoate, or disodium laureth sulfosuccinate.

In embodiments, the non-ionic surfactant is selected from one or more of a fatty alcohol ethoxylate, an alkylphenol ethoxylate, a fatty acid ethoxylate, or an alcohol ethoxylates. In some embodiments, the fatty acid alcohol ethoxylate can be lauryl myristyl alcohol ethoxylate. In some embodiments, the lauryl myristyl alcohol ethoxylate can be:

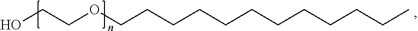

where “n” can be between six and seven. For example, in some non-limiting embodiments the lauryl myristyl alcohol ethoxylate can be Lutensol® A65N.

In some embodiments, the alkylphenol ethoxylate can be octylphenol ethoxylate. For example, the octylphenol ethoxylate can be:

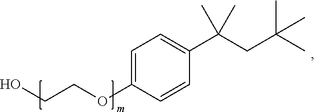

where “m” can be nine or ten. For example, in some non-limiting embodiments the octylphenol ethoxylate can be Triton X-100. As used herein, “Triton X-100” and “TX100” can be used interchangeably.

The non-ionic surfactant described herein, can include, but is not limited to fatty alcohol ethoxylates, alkyl polyglucosides, sorbitan esters (Spans), polyoxyethylene sorbitan fatty acid esters (Tweens), alkyphenol ethoxylates, fatty acid alkanolamides, or poloxamers.

In embodiments, the cationic polyelectrolyte can be selected from one or more of poly(diallyldimethylammonium chloride) (PDADMAC), poly(ethyleneimine) (PEI), a chitosan, poly(allylamine), poly(vinylamine), poly(N-alkyl 4-vinyl pyridinium), poly(N-alkyl 2-vinyl pyridinium), poly([2-(Acryloyloxy)ethyl]trimethylammonium), Poly(N,N-dimethyl-3,5-dimethylene piperidinium chloride), or poly(vinylbenzyltrimethylammonium chloride) (PVBTMACl). For example, in non-limiting embodiments, the cationic polyelectrolyte can be PDADMAC of the formula:

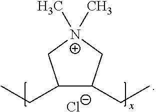

In embodiments, the cationic polyelectrolyte can be present in a concentration of about 0.5 mg/mL to about 30.0 mg/mL. For example, the cationic polyelectrolyte can be present in a concentration of about 0.5 mg/mL, about 0.6 mg/mL, about 0.7 mg/mL, about 0.8 mg/mL, about 0.9 mg/mL, about 1.0 mg/mL, about 1.1 mg/mL, about 1.2 mg/mL, about 1.3 mg/mL, about 1.4 mg/mL, about 1.5 mg/mL, about 1.6 mg/mL, about 1.7 mg/mL, about 1.8 mg/mL, about 1.9 mg/mL, about 2.0 mg/mL, about 2.1 mg/mL, about 2.2 mg/mL, about 2.3 mg/mL, about 2.4 mg/mL, or about 2.5 mg/mL, about 3.0 mg/mL, about 3.5 mg/mL, about 4.0 mg/mL, about 5.0 mg/mL, about 6.0 mg/mL, about 7.0 mg/mL, about 8.0 mg/mL, about 9.0 mg/mL, about 10.0 mg/mL, about 11.0 mg/mL, about 12.0 mg/mL, about 13.0 mg/mL, about 14.0 mg/mL, or about 15.0 mg/mL.

In embodiments, the cationic polyelectrolyte can be present in a concentration or about 1 μM to about 0.5 mM. For example, the cationic polyelectrolyte can be present in a concentration of about 1 μM, about 5 μM, about 10 μM, about 20 μM, about 30 μM, about 40 μM, about 50 μM, about 60 μM, about 70 μM, about 80 μM, about 90 μM, about 100 μM, about 200 μM, about 300 μM, about 400 μM, about 500 μM, about 600 μM, about 700 μM, about 800 μM, about 900 μM, about 1 mM, about 1.5 mM, about 2 mM, about 3 mM, about 4 mM, about 5 mM, about 6 mM, about 7 mM, about 8 mM, about 9 mM, about 10 mM, about 20 mM, about 30 mM, about 40 mM, about 50 mM, about 60 mM, about 70 mM, about 80 mM, about 90 mM, about 0.1 M, about 0.15 M, about 0.20M, about 0.25 M, or about 0.30 M.

The PDADMAC described herein can have a weight average molecular weight of about 100 kDa to about 500 kDa. In some embodiments, the PDADMAC described herein can have a weight average molecular weight of about 100 kDa. In some embodiments, the PDADMAC described herein can have a weight average molecular weight of about 200 kDa to about 300 kDa. In some embodiments, the PDADMAC described herein can have a weight average molecular weight of about 400 kDa to about 500 kDa. In some embodiments, the positively charged nature of the PDADMAC can allow for the formation of a coacervate, as described herein, regardless of the molecular weight. Molecular weight of the PDADMAC can, in embodiments, change the phase boundaries of the coacervation region. For example, a PDADMAC with a higher molecular weight (e.g. about 500 kDa) will require less polymer to reach the coacervate region, whereas for lower molecular weight PDADMAC (e.g. 100 kDa) will require more polymer to neutralize the charge from the micelles in solution.

As used herein, iso-ionic diluent refers to a diluent used to maintain ionic strength and pH withing a solution while the concentration of individual charged species changes. In some embodiments the iso-ionic diluent is a sodium chloride (NaCl) solution. In some embodiments the iso-ionic solution can be in a concentration of about 300 mM to about 500 mM. For example, the iso-ionic solution can be in a concentration of about 300 mM, about 310 mM, about 320 mM, about 330 mM, about 340 mM, about 350 mM, about 360 mM, about 370 mM, about 380 mM, about 390 mM, about 400 mM, about 410 mM, about 420 mM, about 430 mM, about 440 mM, about 450 mM, about 460 mM, about 470 mM, about 480 mM, about 490 mM, or about 500 mM.

In some non-limiting examples, an embodiment of the composition described herein can be an adhesive, a coating, an encapsulation system, a surface modifier, an interfacial spreading mediator, a drug delivery system, or an anti-fouling agent.

The formation and stability of embodiments of the disclosure described herein can be governed by a balance between several factors. Some non-limiting examples of these factors can include the solution environment (e.g. pH, or ionic strength), the composition of the micelles (for example, as such, the Y value (e.g. the mole fraction of the anionic composition within the mixed surfactant micelle), the stoichiometric ratio (W) (e.g. the mass ratio between micelles and polymer), the overall macromolecular concentration (Cₜ), the critical macromolecular concentration (Cₜ′), temperature, pressure, and other physical parameters. These dynamic systems are responsive to environmental changes. As used herein, C′ refers to the macromolecular concentration at which a coacervate forms.

The mole fraction of the anionic surfactant composition (Y) within the mixed surfactant micelle, can be used to describe any one of the embodiments of the composition described herein. In some embodiments, the value of Y can determine the overall charge and conformation of the micelles. In some non-limiting embodiments, as the value of Y increases, the electrostatic interaction between micelles and polymers can become stronger. In some embodiments, this increase in electrostatic interaction can promote the formation of complex coacervates. In some embodiments, the value of Y can be increased such that a precipitate is formed instead of a coacervate.

In embodiments of the composition as described, the molar fraction of the anionic composition (Y) can be about 0.10 to about 0.90. For example, the value of Y can be about 0.05, about 0.06, about 0.07, about 0.08, about 0.09, about 0.10, about 0.12, about 0.14, about 0.16, about 0.18, about 0.20, about 0.22, about 0.24, about 0.26, about 0.28, about 0.30, about 0.32, about 0.34, about 0.36, about 0.38, about 0.40, about 0.42, about 0.44, about 0.46, about 0.48, about 0.50, about 0.52, about 0.54, about 0.56, about 0.58, about 0.60, about 0.62, about 0.64, about 0.66, about 0.68, or about 0.70.

The total macromolecular concentration (Cₜ), as described herein, can refer to the threshold for phase separation observed during dilution-induced complex coacervation. The macromolecular concentration (Cₜ) can reach a critical level (Cₜ′) at which complex coacervation occurs. In embodiments, micelle-polymer complexes can be prepared at high concentrations and remain in a single homogenous phase. Upon dilution, with for example with a diluent (e.g. and iso-ionic solution), the Cₜ can decrease and phase separation can be induced at C_{T}′. In embodiments, this phase separation resulting from decreased total macromolecular concentration (Cₜ′), can induce the formation of a complex coacervate. In some embodiments, this Cₜ′ can be an important parameter when designing coacervates as stimuli-responsive systems. In embodiments, the formation of a complex coacervate induced from dilution of the composition described herein can be used to increase the wettability of a surface and deliver a payload to a surface.

In some non-limiting, exemplary embodiments, the composition described herein can comprise a Cₜ′ of about 1.0 mM, about 6.0 mM, about 11.0 mM, about 16.0 mM, about 21.0 mM, about 26.0 mM, about 31.0 mM, about 36.0 mM, about 41.0 mM, about 46.0 mM, about 51.0 mM, about 56.0 mM, about 61.0 mM, about 66.0 mM, about 71.0 mM, about 76.0 mM, about 81.0 mM, about 86.0 mM, about 91.0 mM, about 96.0 mM, about 101.0 mM, about 106.0 mM, about 111.0 mM, about 116.0 mM, about 121.0 mM, about 126.0 mM, about 131.0 mM, about 136.0 mM, about 141.0 mM, about 146.0 mM, or about 150.0 mM.

As described herein, the mass ratio between micelles and polymer can be represented by the stoichiometric parameter (W). In some embodiments of the composition, complex coacervates described herein can form only within a specific range of W values. In a non-limiting, exemplary embodiment, when W is too low, coacervation does not occur. Further still, in some non-limiting, exemplary embodiments, when W is too high, precipitation can be induced. In non-limiting, exemplary embodiments of the composition described herein, the W value can comprise about 0.05, about 0.06, about 0.09, about 0.10, about 0.13, about 0.17, about 0.21, about 0.20, about 0.25, about 0.29, about 0.33, about 0.37, about 0.41, about 0.45, about 0.50, about 0.55, about 0.57, about 0.61, about 0.65, about 0.69, about 0.73, about 0.77, about 0.81, about 0.85, about 0.89, or about 0.90. In some embodiments, the composition described herein can comprise any combination of Y, W, or Cₜ.

As described herein, embodiments of the invention can be used to wet a surface or increase the wettability of a surface. In some embodiments the surface can be a hydrophobic surface, a rough hydrophobic surface, a superhydrophobic surface, or a hydrophilic surface. In embodiments, the ability of a composition as described herein to wet a surface, or increase the wettability of a surface, can be measured by contact angle. Some other non-limiting, exemplary methods to measure wettability can be advancing contact angle measurements, receding contact angle measurements, tilting plate method, sliding plate method, microscopy-based depositional analysis, droplet shape analysis, or combinations thereof, and the like.

In embodiments, the composition described herein can exhibit a contact angle on a hydrophilic surface of about 7° to about 25°. For example, embodiments of the composition described herein can exhibit a contact angle on a hydrophilic surface of about 7°, about 7.5°, about 8°, about 8.5°, about 9°, about 9.5°, about 10°, about 10.5°, about 11°, about 11.5°, about 12°, about 12.5°, about 13°, about 13.5°, about 14°, about 14.5°, about 15°, about 15.5°, about 16°, about 16.5°, about 17°, about 17.5°, about 18°, about 18.5°, about 19°, about 19.5°, about 20°, about 20.5°, about 21°, about 21.5°, about 22°, about 22.5°, about 23°, about 23.5°, about 24°, about 24.5°, or about 25°.

In some embodiments, the composition described herein can exhibit a contact angle on a rough hydrophobic surface of about 5° to about 25°. For example, embodiments of the composition described herein can exhibit a contact angle on a rough hydrophobic of about 5°, about 5.5°, about 6°, about 6.5°, about 7°, about 7.5°, about 8°, about 8.5°, about 9°, about 9.5°, about 10°, about 10.5°, about 11°, about 11.5°, about 12°, about 12.5°, about 13°, about 13.5°, about 14°, about 14.5°, about 15°, about 15.5°, about 16°, about 16.5°, about 17°, about 17.5°, about 18°, about 18.5°, about 19°, about 19.5°, about 20°, about 20.5°, about 21°, about 21.5°, about 22°, about 22.5°, about 23°, about 23.5°, about 24°, about 24.5°, or about 25°.

In embodiments, the composition described herein can exhibit a contact angle on a hydrophilic surface of about 13° to about 20°. In embodiments, the composition described herein can exhibit a contact angle on a hydrophobic surface of about 11° to about 25°. The composition described herein can exhibit smaller contact angles as compared to other physical states of the system (e.g. precipitates or gels) and smaller contact angles as compared to their micellar components alone.

Further aspects of the invention are drawn towards a method of forming a dilution-induced release composition. Some embodiments of the method comprise providing a solution containing a cationic polyelectrolyte, a mixed surfactant micelle, and an iso-ionic diluent. The cationic polyelectrolyte solution can comprise a cationic polyelectrolyte dissolved in a solution. The mixed surfactant micelle can comprise a non-ionic surfactant and an anionic surfactant in a molar fraction (Y) of about 0.05 to about 0.7. In embodiments, the anionic surfactant, the non-ionic surfactant, and the cationic polyelectrolyte can comprise any of the embodiments described herein.

Further embodiments of the method comprise adding a payload compound to the solution. The payload compound can comprise any embodiment of the payload compositions described herein. In embodiments, the payload of the method can be selected from a hydrophobic compound or a hydrophilic compound. In embodiments, adding a payload compound to the solution containing a cationic polyelectrolyte, a mixed surfactant micelle, and an iso-ionic diluent forms the dilution-induced release composition of the disclosure.

As described herein, properties and/or behavior of the dilution-induced release composition can be controlled by adjusting electrostatic interactions. Electrostatic interactions can comprise adjusting the weight ratio of polymer to total amount of surfactant (W), adjusting the pH, adjusting the molar fraction of the anionic surfactant within the mixed surfactant micelle (Y), adjusting the ionic strength, or adjusting the total macromolecular concentration (C_{T}). In some embodiments, the parameters for adjusting the electrostatic interactions can be adjusted individually or simultaneously. In some embodiments, any combination of the parameters can be adjusted.

As described herein, the cationic polyelectrolyte, the mixed surfactant micelle, and the iso-ionic diluent can form a complex coacervate. As such, for example, a complex coacervate can be formed via a Type I or Type II titration. A Type I titration involves incremental additions of a anionic surfactant into a solution containing a fixed amount of a non-ionic surfactant and a cationic polymer with a iso-ionic diluent. Type I titrations, as described herein can indicate the effect of variation in micelle charge. A Type II titration involves the incremental addition of a preformed micelle of a non-ionic and anionic surfactant, into a cationic polymer solution. Type II titrations, as described herein can indicate the effect of micelle-polymer stoichiometry on phase transitions in a complex coacervate system. In embodiments, the conditions necessary to form a coacervate and/or induce delivery of a payload can be achieved through mixing all of the components described herein together in a highly concentrated mixture and diluting the mixture until the critical macromolecular concentrations (C_{T}′) is reached.

In embodiments of the method described herein, the non-ionic surfactant can be selected from a fatty-alcohol ethoxylate, alkylphenol ethoxylate, fatty acid-ethoxylate, alcohol alkoxylates, or any combination thereof. The anionic surfactant can be selected from an alkyl sulfate, and alky-ether sulfate, an alkylbenzene sulfonate, a sulfosuccinate, or a combination thereof. The cationic polyelectrolyte can be selected from poly(diallyldimethylammonium chloride) (PDADMAC), poly(ethyleneimine) (PEI), a chitosan, poly(allylamine), poly(vinylamine), poly(N-alkyl-4-vinyl pyridinium), poly(N-alkyl-2-vinyl pyridinium), poly([2-(Acryloyloxy)ethyl]trimethylammonium), Poly(N,N-dimethyl-3,5-dimethylene piperidinium chloride), poly(vinylbenzyltrimethylammonium chloride) (PVBTMACl), or a combination thereof. The hydrophobic payload compound can comprise a fungicide, a pesticide, or an herbicide. The partition coefficient (log P) of the hydrophobic payload compound can be about 3.0 to about 7.0, The hydrophilic payload compound can comprise a fungicide, a pesticide, or an herbicide. The partition coefficient (log P) of the hydrophilic payload can be about-4.5 to about 3.0. The iso-ionic diluent of the method described herein can comprise a sodium chloride (NaCl) solution. In embodiments, the iso-ionic diluent solution can be any mineral salt well known in the art.

In some embodiments of the method described herein, the cationic polyelectrolyte and total amount of surfactant can comprise a weight ratio (W) of about 0.01 to about 0.90. The critical total macromolecular concentration (Cₜ′) can comprise about 1.0 mM to about 150 mM. The iso-ionic diluent can be present in a concentration of about 100 mM to about 700 mM.

Further still, aspects of the invention are drawn towards a method of delivering a payload to a surface. The method of delivering a payload to a surface can comprise administering a dilution-induced release composition to a surface and applying a diluent to the dilution-induced release composition. In embodiment, the dilution induced release composition of the method described herein comprises a payload. In some embodiments of the method described herein, the dilution-induced release composition can be of any one of the embodiments described in this disclosure. In embodiments, the administering a dilution-induced release composition comprising a payload to a surface and subsequent dilution of the composition, delivers a payload to a surface.

As described herein, applying a diluent to the dilution-induced release composition comprising a payload that has been administered to a surface increases the wettability of a surface. In embodiments, the dilution decreases the surface tension of the surface of interest relative to the administered dilution-induced release composition, thereby increasing the wettability of a surface.

As used herein, the term wettability refers to a fundamental concept in surface science that describes the ability of a liquid to maintain contact with a solid surface. Wettability can refer to the degree to which a liquid can spread over or adhere to a solid surface. It can be determined by the balance between adhesive forces (i.e. attraction between the liquid and the solid surface) and cohesive forces (i.e. attraction within the liquid molecules). When adhesive forces dominate, the liquid spread, leading to high wettability. Conversely, when cohesive forces dominate, the liquid can tend to form droplets, resulting in low wettability. An example of a cohesive force is surface tension. A property of the dilution-induced release composition. When the surface energy of the surface of interest overcomes the surface tension of the dilution-induced release agent the surface energy, wettability can be increased.

In some embodiments, applying a diluent to the dilution-induced release composition dilutes the composition such that the critical total macromolecular concentration (C_{T}′) is reached inducing the formation of a coacervate within the composition.

As described herein, the dilution of the composition, akin to the adjusting of electrostatic interactions described herein, can induce the formation of a coacervate. The interaction of the coacervate and the payload, for example through the hydrophobic or hydrophilic interactions described herein, can deliver the payload to the surface of interest,

It will be well understood that the dilution-induced release composition can comprise any of the embodiments described herein. In some embodiments the method of administering the composition can comprise spraying, layer-by-layer self-assembly, drop casting, spread coating, or any combination thereof, and the like.

In some embodiments, the surface of interest can comprise a superhydrophobic plant leaf, a rough hydrophobic surface, a plant bark surface, a textile, a printing surface, or a microfluidic device surface. For example, the composition described herein can spread fully on this new surface withing 45-50 seconds. In some embodiments the composition can spread on a surface in less than 45 seconds. In some embodiments, the composition can spread on a surface in greater than 50 seconds. The spreading can be controlled through the control of electrostatic forces and interactions described herein. The spreading of the composition on a surface can be tuned.

A surface, as described herein, can include, but is not limited to any surface that demonstrates Cassie-Baxter wetting behavior. For example, a surface exhibiting Cassie-Baxter wetting behavior derives hydrophobicity from air that is trapped within rough patterns within the surface of said material.

In embodiments, the dilution-induced release compositions described herein can be a coating, an adhesive, an encapsulation system, a surface modifier, an interfacial spreading mediator, a drug delivery system, or an anti-fouling agent. In embodiments, the dilution-induced release compositions described herein can be used for coatings or thin films on hydrophilic and hydrophobic surfaces. In some embodiments, the coacervates can be tested for anti-fouling coatings. In embodiments, the coacervates can act as interfacial spreading mediators to promote uniform film formation in microfluidic or printing applications.

The disclosure will be further described in the following examples, which do not limit the scope of the invention described in the claims.

### EXAMPLES

Examples are provided herein to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

Complex coacervation offers a versatile platform for designing stimuli-responsive materials. Among others, surfactant micelle-polymer complex coacervates provide the added advantage of encapsulating and delivering hydrophobic substances via micellar structures. In this study, we investigate the phase behavior and interfacial properties of a model system composed of mixed surfactant micelles and a cationic polymer. In embodiments, we demonstrate that micelle composition, particularly the fraction of ionic surfactant, governs surface charge and conformation of micelles, which in turn drive phase transitions from soluble complexes to coacervates and ultimately to precipitates. Under iso-ionic dilution, we observe dilution-induced complex coacervation (DICC), with the coacervation window tunable by micelle charge and polymer-to-surfactant stoichiometry. Contact angle measurements reveal that the resulting coacervates spread efficiently on both hydrophilic and hydrophobic surfaces. Notably, they exhibit superior spreading on hydrophobic substrates with multiscale nano-microstructures compared to micelle solutions alone. Without wishing to be bound by theory, this enhanced wetting behavior is driven by the network structure formed by micelle-polymer complexes within the coacervates, which facilitates cooperative surfactant adsorption and promotes the transition from the Cassie-Baxter to the Wenzel wetting regime. These findings underscore micelle-polymer complex coacervates as tunable, stimuli-responsive materials for advanced surface coating applications.

### Introduction

The association of oppositely charged macromolecules in solution can drive liquid-liquid phase separation (LLPS), giving rise to complex coacervation—a process that yields dense, macromolecule-rich liquid phases coexisting with dilute phases^{1, 2}. Governed primarily by electrostatic interactions, complex coacervation is highly responsive to external stimuli such as pH, ionic strength, and concentration, enabling the formation of dynamic, tunable materials³⁻⁵. This versatility has attracted widespread interest across various fields, with systems comprising polyelectrolytes, charged surfactant micelles, or proteins being actively investigated for applications in drug delivery, encapsulation, underwater adhesives, and surface coatings⁵⁻⁸.

Since electrostatic interactions primarily drive the complex coacervation, it can be induced by charge-related parameters such as pH, stoichiometry, and ionic strength of the systems⁹⁻¹¹. In addition to these well-established triggers, the total macromolecular concentration (C_{T}) plays a crucial role in modulating coacervation¹². At concentrations above a certain threshold, coacervate formation is suppressed, and the system remains in a single homogeneous phase—a phenomenon referred to as self-suppression¹². Upon iso-ionic dilution, where only C_{T} is reduced without altering ionic conditions or charge balance, phase separation can reoccur. This phenomenon, known as dilution-induced complex coacervation (DICC) highlights the potential of dilution as a practical and underexplored trigger for stimuli-responsive phase transitions¹². For applications, DICC provides a unique advantage in its simplicity and controllability, enabling the reversible formation of coacervates in response to dilution alone. This mechanism has significant implications for the development of advanced delivery systems and functional coatings. The ability to encapsulate and deposit active components-such as dyes, fire retardants, small molecules or biological macromolecules-onto various substrates in a controlled, dilution-triggered manner opens new avenues for applications across material science, agriculture, and biomedical engineering¹³⁻¹⁵.

Among others, surfactant micelle-polymer systems represent an important subclass of complex coacervates, exhibiting diverse associative phase behaviour that includes soluble complexes, coacervates, and precipitates, depending on formulation conditions^{16, 17}. The phase behaviour of surfactant micelle-polymer systems is strongly influenced by the molecular characteristics of both components. Key variables include the charge density¹⁸, chain flexibility¹⁹, and molecular weight of the polyelectrolytes^{9, 20}, as well as micellar properties such as chain length¹⁸, curvature²¹ and surface charges⁹. In this study, we investigate the phase behaviour of a model surfactant micelle-polymer system comprising a mixed micelle of the anionic surfactant sodium dodecyl sulphate (SDS) and the non-ionic surfactant Lutensol® A65N (LA65N), a linear alcohol ethoxylate. Positively charged poly(diallyl dimethylammonium chloride) (PDADMAC) is used to form complexes with the negatively charged surfactant micelles. We systematically explore how micelle composition (quantified by the mole fraction of SDS, denoted as Y) and polymer-to-micelle stoichiometry govern phase transitions and DICC behaviour in this system. In particular, light scattering and small-angle neutron scattering (SANS) were employed to characterize changes in micellar charge, size, and conformation as a function of the SDS mole fraction within the mixed micelles. These structural variations were then correlated with the phase behavior observed in the system. Our results indicate that the proportion of ionic surfactant significantly influences surfactant packing and the conformation of worm-like micelles. Such structural changes modulate the interaction between micelles and PDADMAC, thereby governing the observed phase transitions in the system.

Complex coacervates are known to possess extremely low surface tension, enabling them to spread efficiently across a wide range of surfaces. This property has inspired numerous studies investigating their interfacial behaviour, particularly on hydrophilic substrates, leading to the development of underwater adhesives²²⁻²⁴, anti-fouling coatings^{25, 26} and tissue engineering scaffolds²⁷⁻²⁹. While these development of applications primarily rely on the ability of complex coacervates to spread on hydrophobic surfaces, a few recent studies have reported strong adhesion of coacervates on hydrophobic surfaces³⁰⁻³².

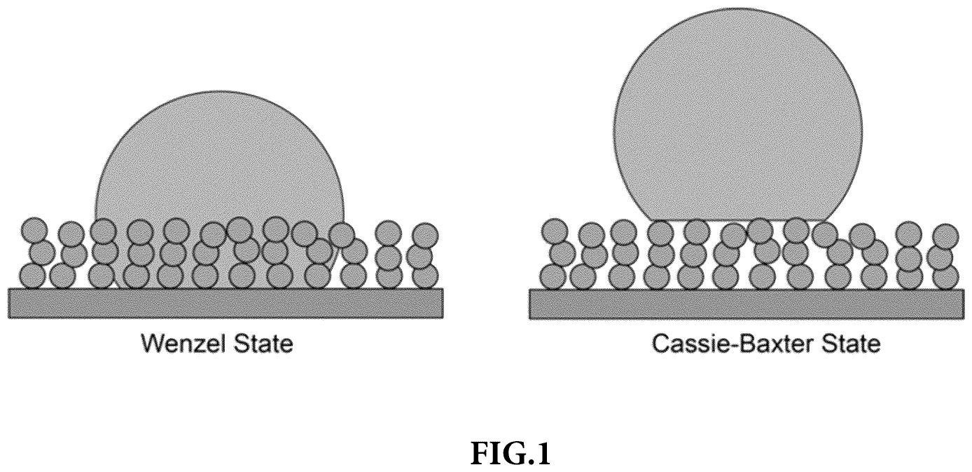

In embodiments described herein, the micelle-polymer coacervates that we made adhered more effectively to hydrophobic surfaces than to hydrophilic ones. This unexpected observation led us to further investigate how they behave when applied to substrates with various hydrophobicity. Since surface hydrophobicity reflects the extent to which a surface resists wetting, it directly influences how coacervate droplets interact with and spread across the surface. The wettability of a droplet on a solid-liquid interface is a balance between surface energies at the interface and is governed by both the chemical composition and physical morphology of the surfaces^{33, 34}. In particular, hydrophobic surfaces can be created by reducing surface energy of the substrate by introducing coatings that are of low surface energy^{35, 36} or by introducing surface roughness at the nano- or microscale to trap air and reduce contact with water³⁷. In nature, many hydrophobic surfaces-such as lotus leaves, insect wings, and bird feathers-achieve water repellency through hierarchical structures that combine surface chemistry with micro- and nanostructured topography. The wettability of a liquid on a solid surface is typically characterized by the static contact angle^{38, 39}. For textured or patterned surfaces, wetting behaviour can generally be described by two classic models: the Wenzel state and the Cassie-Baxter state (FIG. 1)³⁸. In the Wenzel state, the liquid fully penetrates the surface features, with no air trapped under the droplet^{40, 41}. In contrast, the Cassie-Baxter state occurs when the liquid rests on top of the surface asperities, with air trapped in the underlying cavities^{40, 42}. This leads to reduced solid-liquid contact and enhanced water repellency, often resulting in superhydrophobic behaviour.

In embodiments described herein, we prepared rough hydrophobic surfaces by coating glass substrates with methyltrichlorosilane, which subsequently formed polysiloxane nanofilaments as evident by the SEM characterization. Water contact angle measurements confirmed the hydrophobic nature of the resulting surfaces. We then evaluated the wetting behaviour of micelle solutions and their complexes with the cationic polymer PDADMAC on these substrates. Our results show that micelle-polymer coacervates exhibited enhanced spreading compared to micelle solutions alone, underscoring their promise for coating applications on structurally hydrophobic materials commonly found in nature.

### Experimental

Poly(diallyldimethylammonium chloride) (PDADMAC) (400-500 kDa), sodium dodecyl sulfate (SDS), methylene blue and methyltrichlorosilane were purchased from Sigma-Aldrich. Lutensol A65N (LA65N) was kindly provided by BASF SE. Toluene, ethanol, and sodium chloride (NaCl) were purchased from VWR. All chemicals were of analytical grade and used as received without further purification.

Turbidimetric “Type 1” Titrations. To monitor the phase transitions of the SDS/LA65N-PDADMAC system as the micelle charge increased, turbidimetric “Type 1” titrations were performed. In these titrations, the turbidity of sample solutions was measured as 100 T % at 600 nm, where T is the transmittance of the sample. Turbidity measurements were performed on a Cary 60 UV-Vis spectrophotometer equipped with a fiber optic probe. Each titration involved incremental additions (0.02 mL) of a 60 mM SDS solution prepared in 0.4 M NaCl to a mixture of PDADMAC (1.5 g/L) and LA65N (20 mM), also in 0.4 M NaCl. As SDS was titrated into the PDADMAC-LA65N mixture, the turbidity of the solution changed due to the formation of micelle-polymer complexes, as the micelles became increasingly charged. While turbidity measurements effectively tracked the formation of large-scale aggregates, the precise nature of the complexes (liquid versus solid) was further examined using microscopy (Motic Panthera C2 microscope). To represent the increase in SDS during the Type 1 titration, the mole fraction of SDS is represented as Y and it can be calculated using the following equation:

$$Y = \frac{[ SDS ]}{[ SDS ] + [ LA 65 N ]} \qquad Eq . 1$$

Where [SDS] is the concentration of SDS, and [LA65N] is the concentration of LA65N. Throughout the Type 1 titration, the total macromolecular concentration (C_{T}) ranged from 20 to 31 mM.

Turbidimetric “Type 2” Titrations. While Type 1 titrations focused on micelle charge variation, Type 2 titrations were performed to investigate the effect of micelle-polymer stoichiometry on phase transitions in the SDS/LA65N-PDADMAC system. Similar to Type 1 titrations, turbidity was measured as 100-T % at 600 nm using a Cary 60 UV-Vis spectrophotometer equipped with a fiber optic probe. However, instead of titrating SDS into a polymer-surfactant mixture (as in Type 1), Type 2 titrations involved titrating preformed SDS/LA65N micelles into PDADMAC solutions. This approach allowed for a systematic investigation of polymer-surfactant interactions across different stoichiometric conditions, while keeping pH and ionic strength constant. As in Type 1 titrations, turbidity changes indicated the formation of micelle-polymer complexes, and the transition points were further examined using microscopy to distinguish between liquid-like and solid-like aggregates. To quantify the effect of stoichiometry variation, the polymer-surfactant mass ratio (W) was used to describe the relative amount of polymer to micelles in the system. Throughout the Type 2 titration, the total macromolecular concentration (C_{T}) spanned from 1.5 to 45 mM.

Iso-ionic Dilution Experiments. To map the phase boundaries of the SDS/LA65N-PDADMAC system while decreasing the total macromolecular concentration (C_{T}), iso-ionic dilution experiments were performed by adding 0.4 M NaCl solution to a polymer-surfactant mixture, also prepared in 0.4 M NaCl. This ensured that during titration, only C_{T} decreased, while pH, ionic strength, and micelle-polymer stoichiometry (W) remained constant, defining the iso-ionic dilution conditions. For each dilution experiment, the initial C_{T} varied depending on the W and Y values used to prepare the polymer/micelle complexes, but was generally around 380 mM. As C_{T} decreased to a critical level (C_{T}′), dilution-induced complex coacervation (DICC) occurred. Therefore, the onset of DICC was characterized by C_{T}′, which defined the phase boundary of each SDS/LA65N-PDADMAC system (prepared at a particular Y and W values). During the dilution experiments, turbidity of the sample was measured using a similar approach.

Dynamic Light Scattering (DLS) Measurements. The hydrodynamic radius (Rₕ) and zeta potential (ζ) of SDS/LA65N micelles were measured across a range of Y values using a Litesizer 500 DLS instrument (Anton Paar, USA) equipped with a 658 nm single-wavelength laser diode, operating at 20° C. All samples were prepared in 0.4 M NaCl solution, which was filtered using 0.2 μm syringe filters. In the mixed micelle systems, the SDS concentration was maintained at 3.2 mg/mL, while the concentration of LA65N was adjusted to achieve the desired Y values. Samples were prepared and mixed overnight to ensure complete hydration and equilibration. Prior to measurement, the samples were centrifuged at 12,500 rpm for 15 minutes to remove impurities. The Rₕ was calculated using the Stokes-Einstein equation:

$${R}_{h} = \frac{{k}_{B} T}{6 π η {D}_{T}} . \qquad Eq . 2$$

Where, k_{B}, is the Boltzmann constant, η, is the solvent viscosity, D_{T}, is the translational diffusion coefficient, and T is the absolute temperature in Kelvin. Zeta potential of samples were determined by measuring the electrophoretic mobility μ of sample in the presence of an electric field. For the zeta potential measurements, solution samples were loaded into a Univette, the mobility of the samples were calculated as:

$$μ = \frac{v}{E} . \qquad Eq . 3$$

Where v is the particle velocity and E is the applied electric field strength. The zeta potential ζ of samples were related to μ through the Henry equation:

$$μ = \frac{2 ε ζ f ( k α )}{3 η} . \qquad Eq . 4$$

Where h is the solution viscosity, e is the dielectric constant of the solution, and f(ka) is Henry's function. Measurements were performed in triplicate, and the averaged results were reported with the standard deviation represented as error bars. Total surfactant concentration ranges from 19 mM to 222 mM.

Small-Angle Neutron Scattering Measurements. Small-angle neutron scattering (SANS) experiments were performed to characterize the conformational changes of SDS/LA65N micelles across different Y values. Measurements were conducted at CG-3 Bio-SANS at the High Flux Isotope Reactor (HFIR), Oak Ridge National Laboratory (ORNL), Oak Ridge, TN. Micelles were prepared at varying Y values in 0.4 M NaCl solution in D₂O to reduce incoherent scattering from hydrogenated solvents and to enhance contrast. All measurements were performed using one of two different configurations of the Bio-SANS instrument. First configuration, with the main detector at 15.5 m and the curved wing detector rotation at 1.4°, provided a wide q-range of 0.003 Å⁻¹ to 0.8 Å⁻¹, while the second covered a smaller range of q of 0.007 Å⁻¹ to 0.8 Å⁻¹ by placing the main detector at 7 m and the curved wing detector rotation at 3.2°. The advantage of the second configuration is that it offers a narrower q-range and higher neutron flux, which is achieved by reducing the distance between the source and sample apertures from 17.7 m to 9.7 m, while keeping the source and sample aperture diameters constant at 40 mm and 14 mm, respectively. All measurements were performed with a neutron wavelength of 6 Å. Data reduction was performed using the facility-developed software, drtsans, to obtain the scattering intensity I(q) on an absolute scale as a function of q⁴³. The reduced data from the experiment was subsequently analyzed by using the NCNR analysis macros embedded within IgorPro software package^{44, 45}. The scattered intensity of I(q) is recorded as a function of scattering vector q. The scattering vector q is expressed as 4π sin q/λ, where 2q is the scattering angle between incident and scattered beam. For a system containing monodisperse, homogeneous and isotropic dispersion of spherical particles, I(q) can be expressed as:

$$I ( q ) = ϕ {{V}_{p} ( Δ ρ )}^{2} P ( q ) S ( q ) \qquad Eq . 5$$

Where f is the volume fraction of scattering particle with volume Vₚ, Δρ is the difference in scattering length densities (SLD) between the particles being measured and the solvent background. P(q) and S(q) are the form factor and structure factor of the scattering particle, respectively. Scattering profiles measured from micelle samples were fitted using a model that considers micelles as flexible cylinders with cylinder radius polydispersity index using SASVIEW 6 package^{46, 47}. The scattering intensity measured from such sample can be expressed as:

$$I ( q ) = Scale 〈 {F}^{2} 〉 / V + background \qquad Eq . 6$$

where Scale is the scaling factor; V is the volume of the scattering object; <F²> is ensemble-averaged squared form factor amplitude and the background term accounts for incoherent scattering contributions. Structural parameters of the fit model are contour length, Kuhn length, mean cylinder cross section radius and radius polydispersity index. Our fitting results showed strong correlation between the Kuhn length and the contour length fit parameters and allowing both parameters to fit led to instability. To improve fitting stability, the Kuhn length was fixed to the average value of Kuhn length, 14 Å, determined by fitting the dataset with all structural parameters as fitting parameters. With the Kuhn length fixed, only the contour length was varied in subsequent analysis to ensure consistent and reliable fitting results. Gaussian distribution was selected for modeling cylinder radial polydisperse distribution and the polydispersity index from our fits were found to be constant at approximately 0.19±0.02. Such polydispersity falls within the range reported in the literature for surfactant micelles analyzed by small-angle scattering, which spans from approximately 0.1 to 0.3⁴⁸⁻⁵¹. Several factors may contribute to the observed variation in cylindrical radius. First, micelles are dynamic assemblies that undergo constant exchange of surfactant molecules, which inherently leads to size fluctuations. Second, long anisotropic micelles often adopt elliptical rather than perfectly circular cross sections, resulting in apparent radial variation depending on orientation. Finally, the micelles in this study are composed of a mixture of surfactant molecules with differing headgroup and tail chemistries, which likely enhances structural heterogeneity.

Uncertainty analysis was conducted to determine the σᵢ error bars for each fitting parameter. This process involved calculating the degrees of freedom for each dataset and applying a scaling factor corresponding to a 68.3% confidence level, typically ranging from 1.000 to 1.100, based on standard statistical tables⁵². The best-fit chi-squared value was multiplied by this scaling factor to obtain the threshold for the uncertainty bounds. For each fitting parameter, the chi-squared value was plotted as a function of the parameter value. The best-fit result was identified at the minimum of this curve, and the ±σᵢ bounds were defined by the parameter values at which the chi-squared reached the scaled threshold. This procedure was repeated independently for each fitting parameter, and the resulting ±σᵢ values are reported as the uncertainties.

Hydrophobic Surface Preparation. Hydrophobic surfaces were prepared according to a previously reported method⁵³. Briefly, microscope glass slides were cleaned in a UV-ozone oven for 15 minutes, then immersed in toluene containing methyltrichlorosilane along with concentrated hydrochloric acid. The container holding the glass slides was then sealed and stored at 4° C. for 5 hours to facilitate the reaction. Upon completion of the reaction, the glass slides were thoroughly rinsed and dried in an oven at 100° C. for 5 minutes. The resulting surfaces were characterized using scanning electron microscopy (SEM) with an FEI Quanta 3D FEG Ga FIB/SEM instrument.

Contact Angle Measurements. Contact angle measurements were performed to evaluate the wettability and interfacial behaviour of micelles and their complexes with polymers on various surfaces. A Ramé-Hart goniometer (Model 210) was used to conduct the measurements. A 3 μL droplet of each sample was dispensed onto glass substrates that were either hydrophilic (UV-ozone cleaned) or hydrophobic (methyltrichlorosilane-treated). Due to the dynamic nature of the samples, particularly those containing surfactants, reliable advancing and receding contact angle (ACA/RCA) measurements could not be obtained, as the droplets began to spread immediately upon contact with the surface. To ensure consistency and reproducibility, static contact angles were recorded exactly one minute after droplet deposition at seven different spots on each slide, and the average value was reported.

### Non-Limiting Results and Discussion

### Effect of SDS Mole Fraction (Y) on Micelle Properties and Phase Behaviour in the SDS/LA65N-PDADMAC System

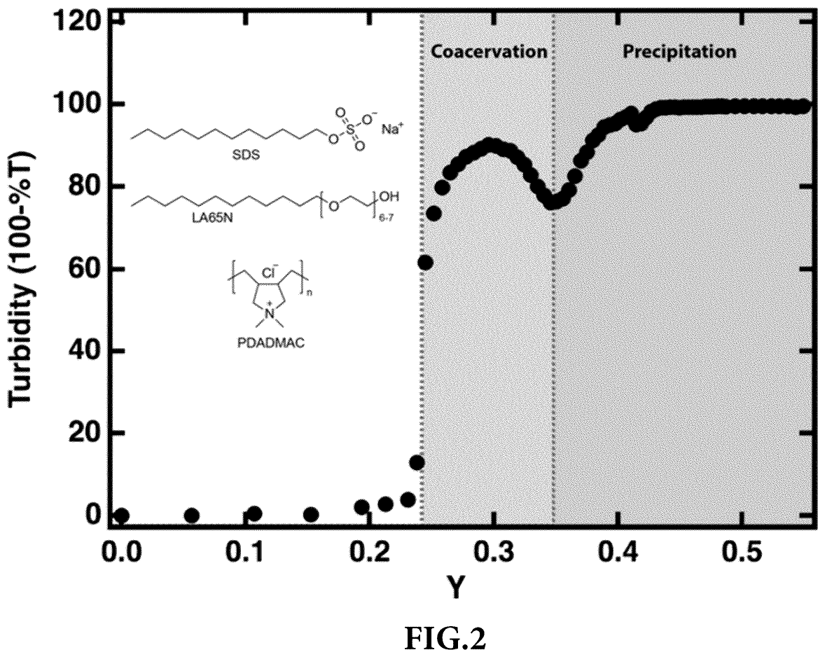

In this study, Type 1 titrations were performed to investigate the phase behaviour of the SDS/LA65N-PDADMAC system as the micelle charge increased (FIG. 2). PDADMAC is a charged polymer composed of repeating units bearing quaternary amine groups, it remains positively charged under all pH conditions. Mixed surfactant micelles were prepared using SDS, an anionic surfactant with a 12-carbon alkyl chain as the hydrophobic tail and a negatively charged sulfate group as the hydrophilic head, and LA65N, a nonionic surfactant with a 12-14 carbon alkyl chain as the hydrophobic tail and 6-7 ethylene oxide units as the hydrophilic head (FIG. 2). Since the charge of the mixed micelles originates from SDS, the percentage of SDS within the micelle determines the electrostatic interactions between the micelles and the positively charged PDADMAC polymer. During titration, SDS molecules were gradually introduced into the LA65N-PDADMAC mixture, increasing the negative charge of the micelles as more SDS was incorporated. Turbidimetric measurements were used to track phase transitions as a function of SDS mole fraction (Y). The turbidity is plotted against Y where turbidity can be denoted as 100−% Transmittance (T). As shown in FIG. 2, the solution remained transparent, i.e. low turbidity when the Y values were small, indicating the presence of small, soluble micelle-polymer complexes. As Y increased to 0.23, a significant increase in turbidity was observed, marking the onset of complex coacervation. Microscopy images confirmed the formation of liquid-like coacervate droplets, indicative of LLPS. As Y increased further, the micelles became highly charged, resulting in strong micelle-polymer interactions that ultimately led to precipitation, forming tightly bound micelle-polymer aggregates. These results are in close agreement with our previous study 9, confirming that a sufficient micelle charge is necessary for phase separation and the formation of coacervates in micelle-polyelectrolyte systems.

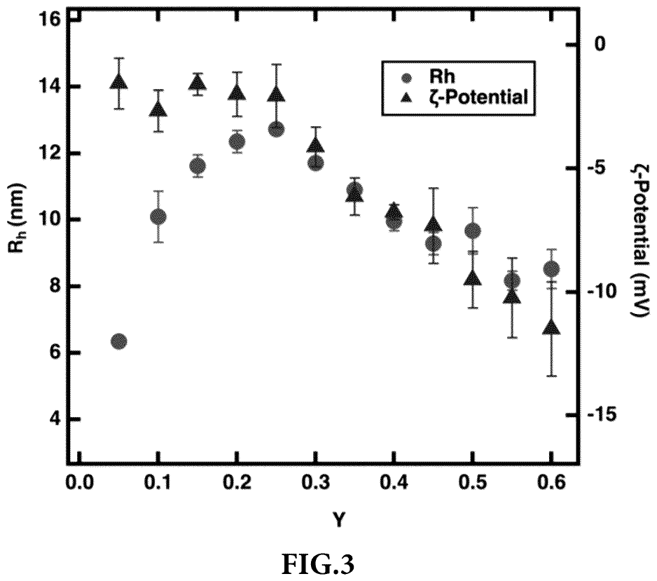

To better understand the phase behavior of the SDS/LA65N system observed in Type 1 titration, micelles prepared at various Y values were subjected to light scattering experiments, through which their size (Rₕ) and charge ((ζ-potential) were measured. As shown in FIG. 3 that the micellar Rₕ increased from ~6 nm at Y=0.05 to 13 nm at Y=0.25, before decreasing to ~9 nm at Y=0.6. Meanwhile, ζ-potential remained constant up to Y=0.25, despite the incorporation of additional SDS molecules. Beyond Y=0.25, micelles became progressively more negatively charged, marking a critical transition in micelle charge. Without wishing to be bound by theory, the observed size increase at lower Y values indicates that SDS was gradually incorporated into preformed LA65N micelles, expanding the micellar structure without significantly altering charge. Without wishing to be bound by theory, this occurred because SDS headgroups were initially shielded within the bulkier LA65N headgroups, preventing an immediate increase in-potential. As Y exceeds 0.25, the increased surface density of SDS causes greater exposure of the charged headgroups, intensifying electrostatic repulsions. These repulsive forces could limit micelle growth, resulting in a decrease in overall micelle size. The observed transition in charge and size closely coincides with the onset of complex coacervation at Y=0.23, observed in Type 1 titration. Since electrostatic interactions are the primary driving force for coacervation, the fact that micelle charge only increases significantly beyond Y=0.25 explains why coacervation occurs around this point. Below this threshold, the micelles lack sufficient charge to strongly interact with PDADMAC and induce phase separation. As Y increases, micelles acquire enough negative charge to form charge-neutral species, allowing the formation of large coacervate networks.

### Dilution-Induced Complex Coacervation (DICC).

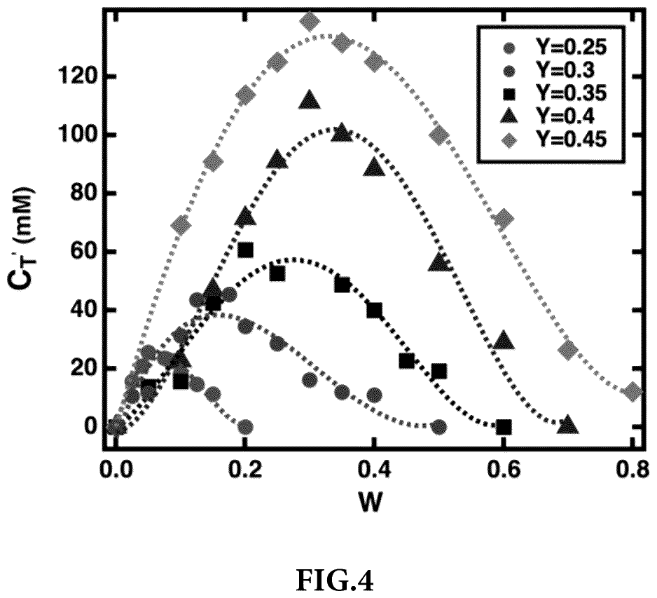

From Type 1 titration, we learnt that micelles must be prepared at specific Y values to ensure sufficiently strong electrostatic interactions for phase transitions to occur in their complexes with PDADMAC. Based on this, DICC experiments were conducted by preparing micelles at Y values ranging from 0.25 to 0.45 and mixing them with PDADMAC at varying polymer-to-surfactant mass ratios (W). During DICC, phase-suppressed solutions containing concentrated surfactant and polymer were gradually diluted with 0.4 M NaCl solution, reducing the total macromolecular concentration (C_{T}) while maintaining constant ionic strength. As dilution progressed, complex coacervation was induced. As shown in FIG. 4, the coacervation region was smallest for micelles prepared at lower Y values, whereas micelles with higher Y values exhibited an expanded coacervation region. Additionally, for each Y, a maximum CT′ was observed at a specific W. The W value corresponding to C_{T′max} increased as Y rose from 0.25 to 0.4 but remained relatively constant as Y increased further to 0.45. Notably, for Y beyond 0.4, while the W value at which C_{T′max} was observed remained unchanged, the dilution curve expanded, indicating that less dilution was required for phase separation at higher Y values.

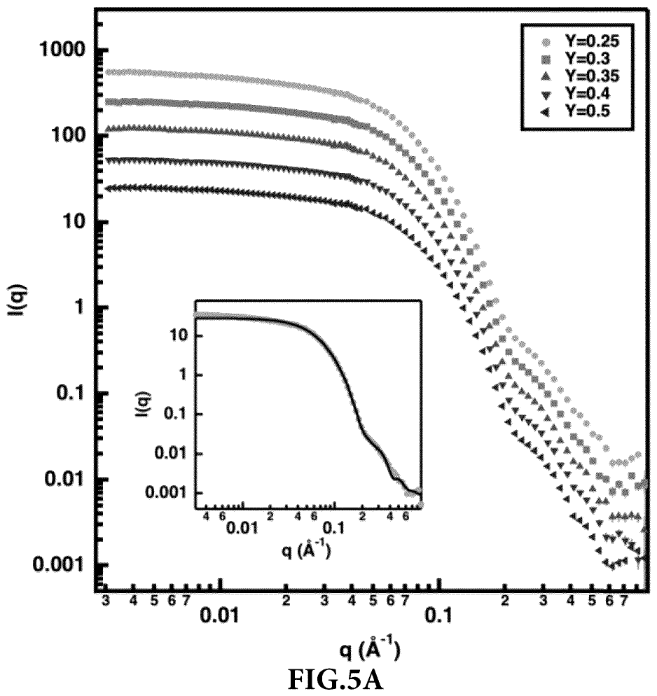

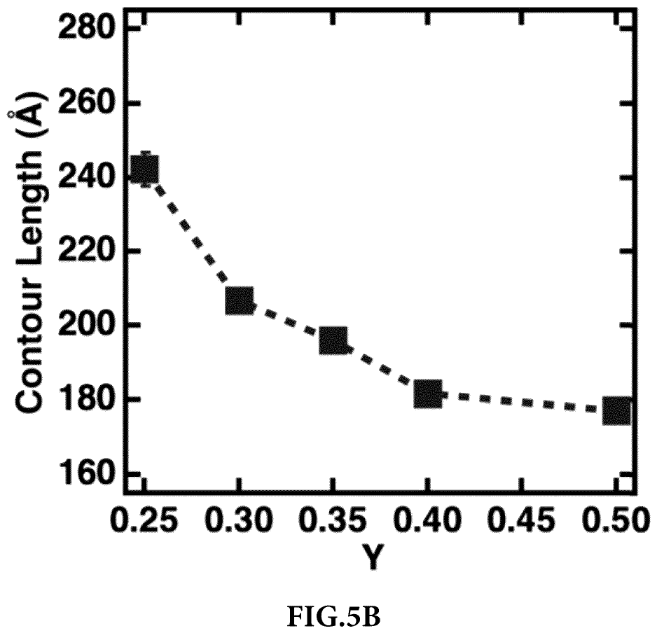

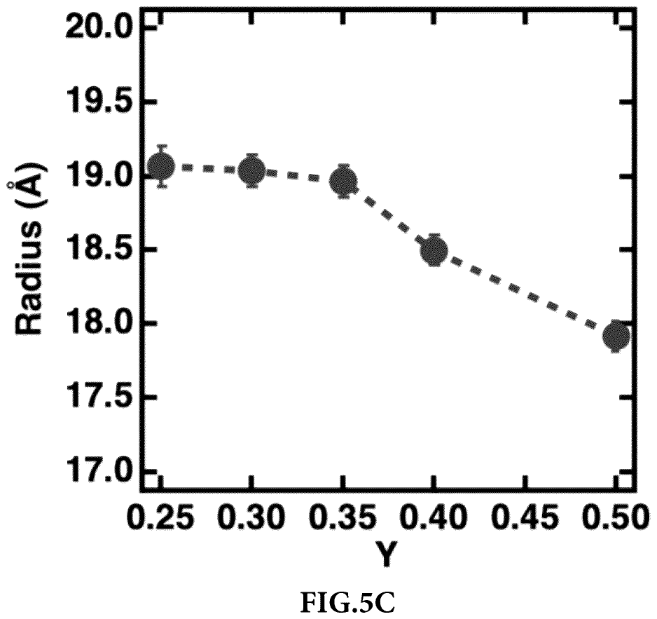

Conformation of Micelles Characterized by Small-Angle Neutron Scattering (SANS). SANS experiments were conducted to characterize the conformational changes of micelles as the Y values increased from 0.25 to 0.50, since 0.25 is the transition point where complex coacervation first emerged. Scattering profiles measured from all micelle samples showed no significant upturn or downturn in the low-q region, indicating that the micelles did not form aggregates or exhibit significant inter-micellar repulsions (FIG. 5A-5C). Without wishing to be bound by theory, the scattering profiles were suitable for shape-dependent modelling to describe the shape and size of the micelles. The scattering data were fitted to flexible cylinders with circular cross section^{46, 47}. Structural parameters were extracted from the fits, including contour length, which represents the total length of the micelle, as well as the radius of the circular cross section. The fitted parameters are presented in FIG. 5B-5C.

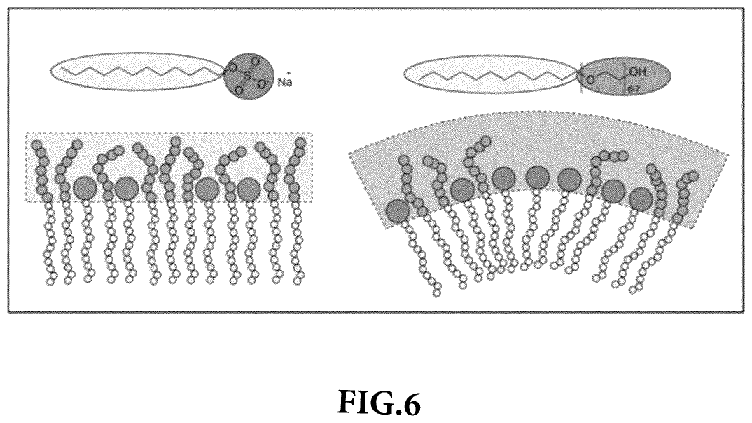

As the Y value (SDS mole fraction) increased from 0.25 to 0.5, changes in micelle conformation were evident from the fitting results. The contour length decreased sharply between Y=0.25 and Y=0.35, then continued to decrease more gradually as Y increased to 0.5. Without wishing to be bound by theory, increasing SDS content within the mixed micelles resulted in a reduction in the overall length of cylindrical micelles. Fitting results for the cylinder radius show that the radius remained relatively constant between Y=0.25 and 0.35, followed by a measurable decrease of approximately 8% as Y increased from 0.35 to 0.5. Combining results from DLS and SANS, and without wishing to be bound by theory, the conformation of SDS/LA65N micelles changed progressively with increasing Y. In the range of Y=0 to 0.25, the incorporation of SDS into the micelles led to an increase in micellar size, while the apparent surface charge remained relatively constant. This can be attributed to the low SDS content per micelle and the shielding of negatively charged SDS headgroups by the neutral ethylene oxide chains of LA65N (FIG. 6). As Y increased from 0.25 to 0.35, a decrease in Rₕ was observed alongside a rise in zeta potential. SANS analysis revealed a concurrent reduction in micelle contour length. Together, the DLS and SANS results indicate that in this Y range, the negative charge of incorporated SDS molecules became more pronounced. Without wishing to be bound by theory, this increase in surface charge led to a reduction in micellar size, either through physical shortening or a conformational transition to a more coiled structure. Beyond Y=0.35, the contour length appeared to stabilize. However, continued incorporation of SDS further elevated the surface charge. To accommodate the resulting electrostatic repulsion among SDS headgroups, the micelles adopted a more curved conformation, leading to a decrease in cross-sectional radius (FIG. 6).

It is worth noting that the Type 1 titration results indicate that at Y=0.35, the SDS/LA65N-PDADMAC system entered the precipitation region, where micelle-polymer interactions become sufficiently strong to induce the formation of irregularly shaped precipitates. The structural changes observed in the micelles—specifically, the reductions in contour length and cross-sectional radius—are, without wishing to be bound by theory, driven by an increase in micellar charge density. While shorter micelles can offer fewer total binding sites, the higher surface charge and increased curvature can enhance localized electrostatic interactions, promoting more effective binding with the oppositely charged polymer. Thus, the onset of precipitation at Y=0.35 can result from a combined effect of increased micellar charge and structural reorganization, which together strengthen micelle-polymer interactions.

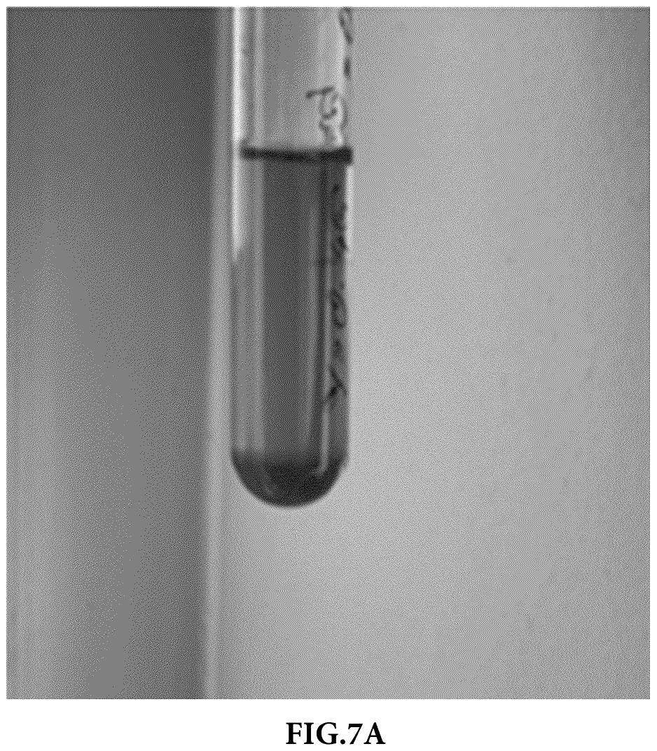

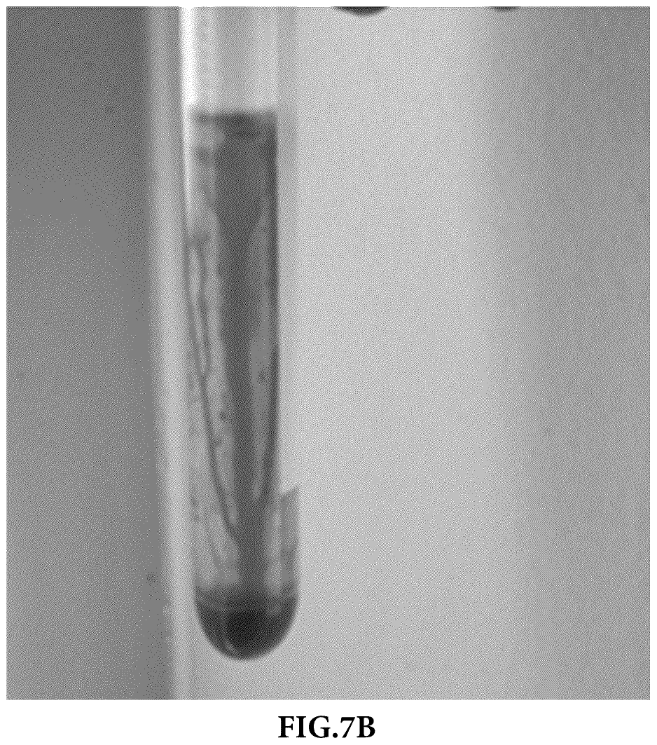

SDS/LA65N complex coacervates exhibited strong adhesion to rough hydrophobic surfaces. During DICC experiments, an intriguing phenomenon was observed when coacervates formed. Typically, coacervates separate from the bulk solution as a dense liquid phase and settle at the bottom of the container. This behavior was observed when DICC experiments were conducted in glass test tubes, where the coacervates readily settled (FIG. 7A). However, when the same experiments were performed in polypropylene test tubes, a striking difference was noted-SDS/LA65N-PDADMAC coacervates strongly adhered to the inner walls of the tube, even when left undisturbed overnight (FIG. 7B). While some coacervates eventually settled at the bottom of the polypropylene tube, considerable amount of coacervates remained attached to the tube walls even after weeks. This unexpected finding inspired us to further investigate into the spreading behavior of SDS/LA65N-PDADMAC complex coacervates on surfaces with varying hydrophobicity.

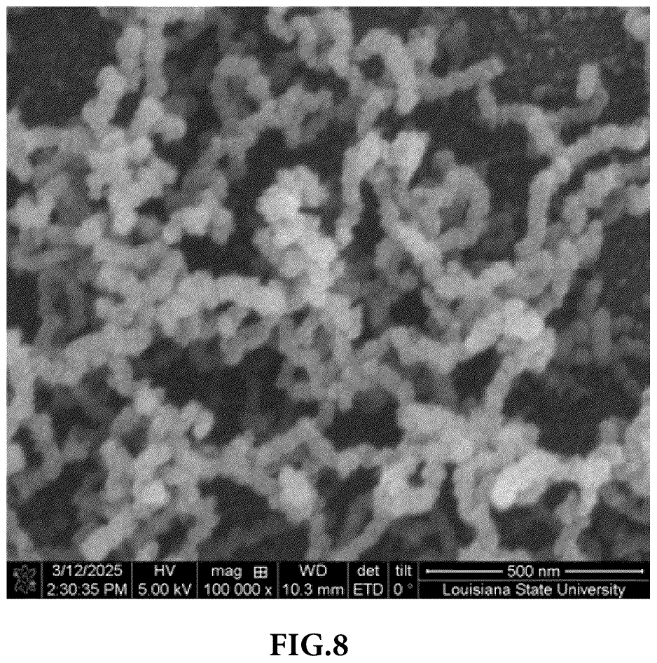

In this study, surfaces with distinct hydrophobicity were prepared to investigate their interaction with coacervates. A hydrophilic surface was obtained by subjecting glass slides to UV-ozone treatment, resulting in a water contact angle of approximately 19°. In contrast, a hydrophobic surface was generated by coating glass slides with methyltrichlorosilane, yielding a water contact angle of ~135°. SEM analysis of the methyltrichlorosilane-coated surface (FIG. 8) revealed the formation of polysiloxane nanofilaments, which self-assembled into a three-dimensional network. This nanostructured morphology resembles that observed in naturally hydrophobic surfaces, such as lotus leaves, where hierarchical roughness enables the entrapment of air pockets. The presence of these air pockets at the solid-liquid interface minimizes contact between the water droplet and the surface, thereby enhancing hydrophobicity through the Cassie-Baxter wetting regime⁵⁴.

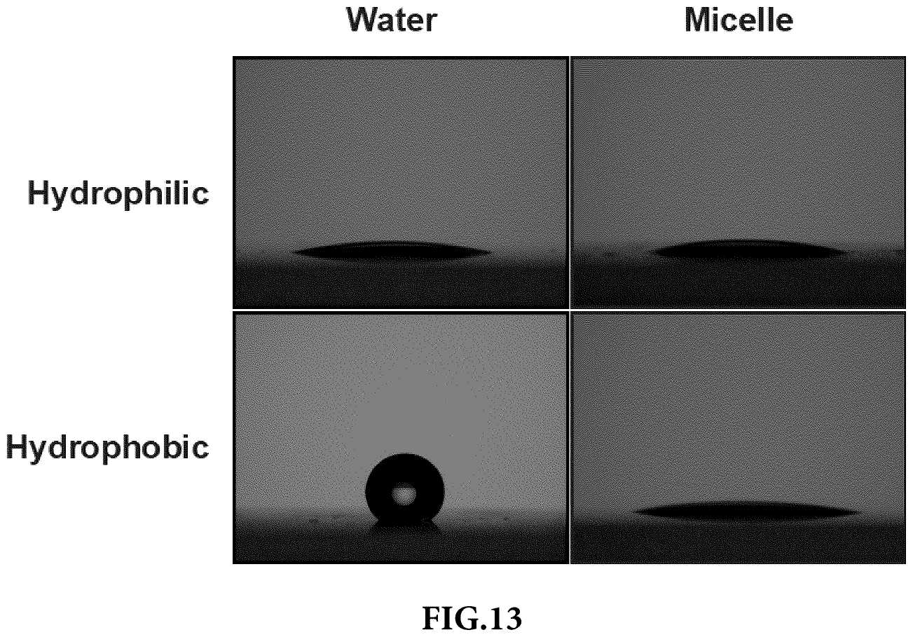

We measured the contact angles of SDS/LA65N micelles prepared at Y=0.4 and their complex coacervates on hydrophilic and hydrophobic surfaces. The contact angle of the micelle solution on the hydrophilic surface was measured at approximately 18°, which is comparable to the water contact angle of ~19° on the same surface. On the hydrophobic surface, the contact angle of the micelle solution decreased to c.a. 18° (as compared to the water contact angle at 135°) indicating enhanced spreading. This reduction in contact angle is attributed to the adsorption of surfactant molecules at the solid-liquid interface, which lowers the interfacial tension and promotes water spreading on the hydrophobic surface (FIG. 13).

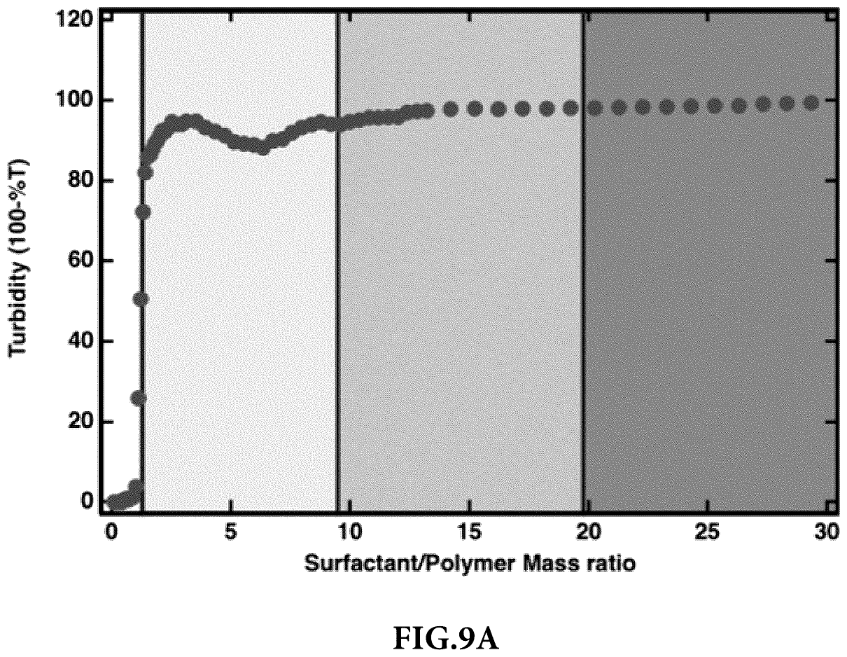

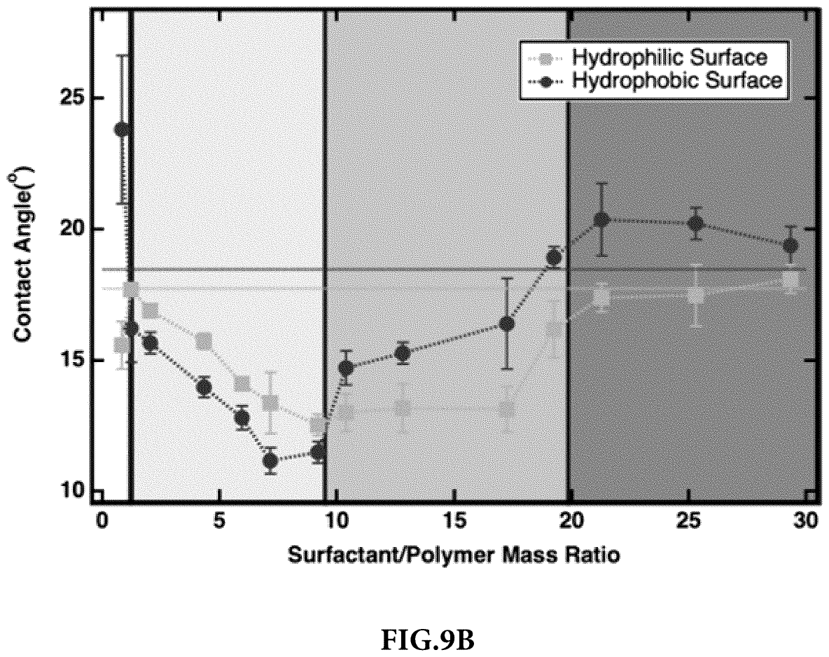

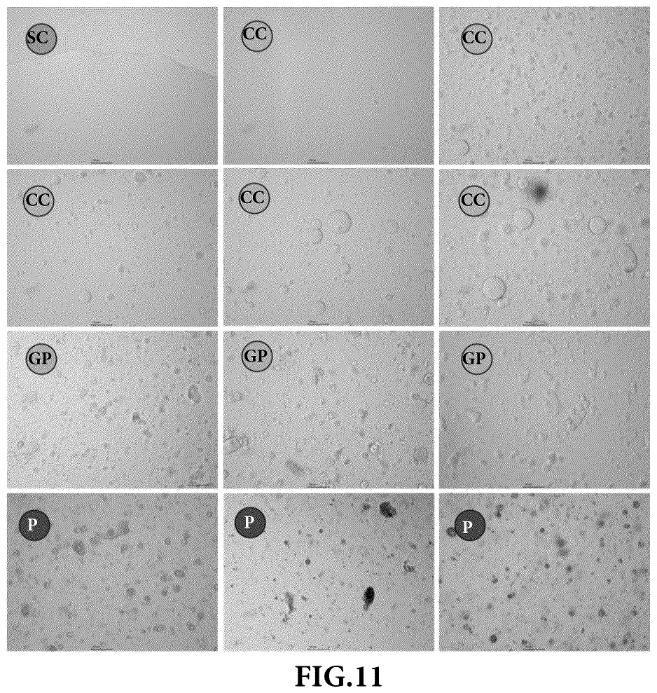

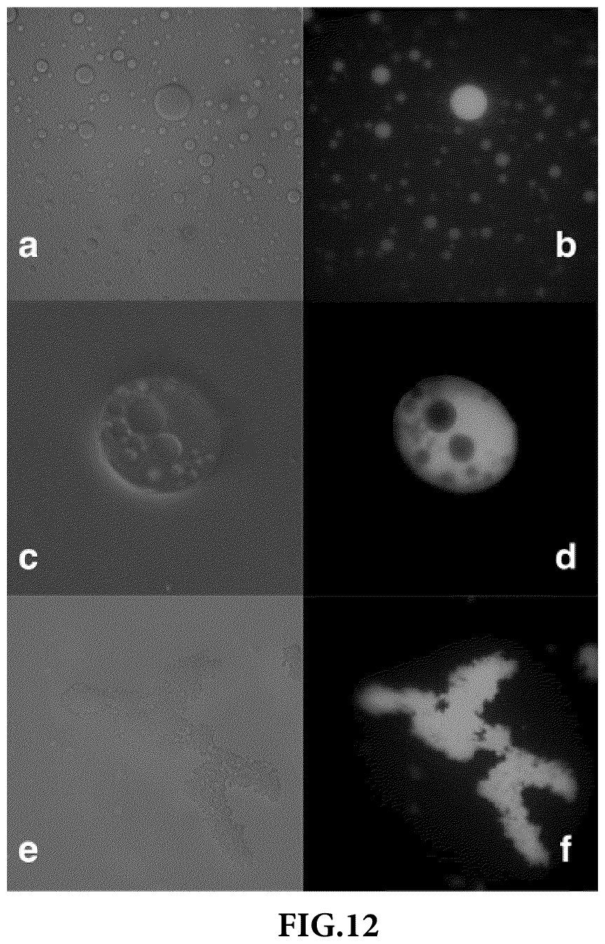

Since complex coacervates can be formed using different approaches, a Type 2 titration was performed by titrating SDS/LA65N micelles (prepared at Y=0.4) into a PDADMAC polymer solution for surface studies. During the titration, the initially clear system became turbid at a surfactant-to-polymer mass ratio of c.a. 1, indicating the formation of larger macromolecular complexes (FIG. 9A). To better characterize the resulting phases, we examined the samples under a microscope. At early titration stages, we observed spherical liquid droplets, consistent with the morphology of classical complex coacervates. As titration progressed, the droplets began to display a “droplets-in-droplets” appearance. Fluorescence labelling of the micelles using Nile Red dye allowed us to visualize their distribution within the “droplets-in-droplets” structure using fluorescence microscopy (FIGS. 11 and 12)⁵⁵. These observations revealed that the internal droplets corresponded to void spaces depleted of micelles, while the surrounding matrix was enriched in micelle-polymer complexes. Due to the absence of a homogeneous, liquid-like structure, we classified this phase as gel-like. Upon further micelle addition, solid, irregularly shaped precipitates formed (FIGS. 11 and 12), indicating a transition to a solid-separated phase.

To further investigate how micelle-polymer complexes spread on different surfaces, aliquots from the Type 2 titration (FIG. 9A) were deposited onto both hydrophilic and hydrophobic substrates and contact angle measurements were performed (FIG. 9B). At low surfactant-to-polymer mass ratios (below 1), the system is primarily populated with intrapolymer complexes and potentially excess free PDADMAC molecules. In this regime, the contact angle on hydrophobic surfaces was significantly reduced compared to that of pure water, due to the presence of surfactant molecules lowering the surface tension. However, the contact angle on hydrophobic surfaces remained much higher than on hydrophilic surfaces. This observation is consistent with the behaviour of PDADMAC alone, which exhibits a contact angle of 132° on hydrophobic surfaces and 16° on hydrophilic surfaces.

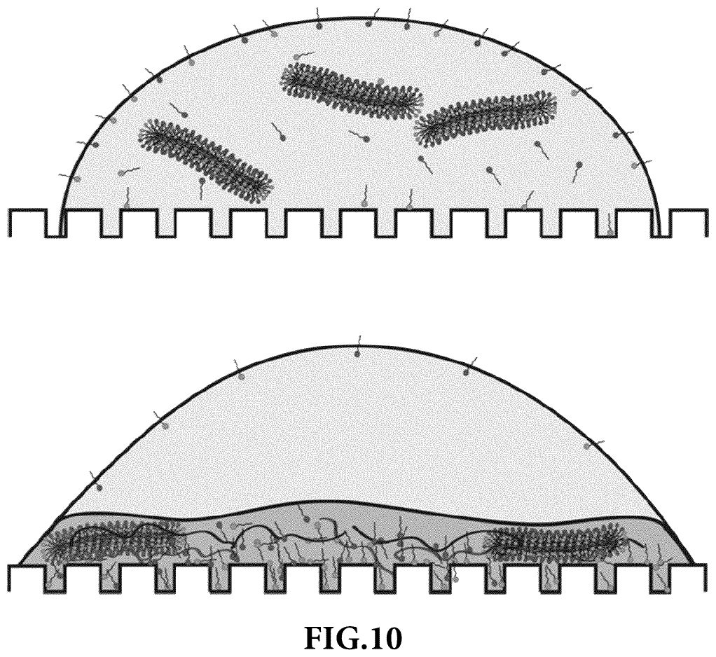

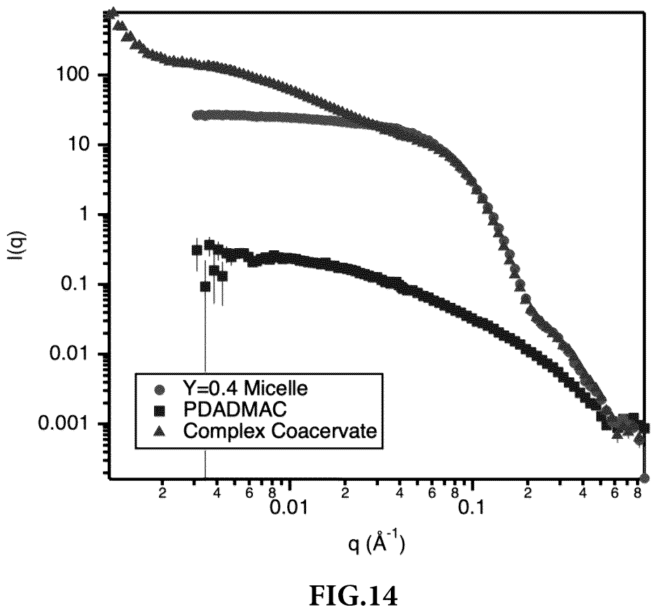

As more surfactant was added and complex coacervates began to form (surfactant-to-polymer mass ratio between 1 and 9), the contact angles measured on both hydrophilic and hydrophobic surfaces decreased. It is worth noting that coacervates exhibited lower contact angles than micelle solutions alone, indicating enhanced spreading behaviour on both surfaces. This effect was particularly pronounced on hydrophobic substrates, where the contact angle dropped below that measured on hydrophilic surfaces, indicating that coacervates spread more readily on hydrophobic surfaces than on hydrophilic ones. To understand the enhanced spreading demonstrated by the coacervates compared to the micelle solution alone, we refer to the SANS results obtained for the coacervates (FIG. 14). The scattering profiles of the coacervates differ markedly from those of micelle or PDADMAC solutions alone, showing a distinct low-q upturn that signals the formation of larger-scale structures. These features suggest that micelles and polymers are not merely coexisting but are forming hierarchical networked complexes. Our previous studies on colloid-polymer coacervates have shown that such complexes are composed of intertwined colloids and polymers (in this case the micelles and polymers), forming cohesive networks with internal connectivity^{12, 56, 57}. Without wishing to be bound by theory, this network architecture underlies the improved spreading observed for coacervates, particularly on rough hydrophobic surfaces. Within this structure, micelles are embedded in a polymer-rich matrix rather than floating freely in solution. When the coacervate droplet comes into contact with a surface, some micelles at the interface can adsorb onto the surface. Due to the interconnected network, this localized interaction can draw in surrounding micelles and polymer chains, effectively amplifying surfactant deposition and promoting a more uniform wetting front (FIG. 10). This coordinated behaviour contrasts with micelle solutions, where micelles move independently and are limited by diffusion. Moreover, coacervates inherently concentrate micelles relative to bulk solution. At these elevated local concentrations, surfactant adsorption is more effective at reducing surface and interfacial tensions—especially at concentrations way above the critical micelle concentration (CMC), where, as shown in the Shardt study⁵⁸, the Cassie-Baxter state becomes unstable and collapses more readily into the Wenzel state. Therefore, it is anticipated that the high local surfactant concentration and the cooperative, networked structure of coacervates lead to more efficient and robust spreading on rough hydrophobic surfaces than surfactant micelles alone.

As more micelles were added to the system, the initially uniform coacervate droplets gradually disappeared, and the samples became populated with droplet-in-droplet structures. We refer to this regime as the gel phase, as the samples are no longer well-defined coacervate droplets, nor are they irregular aggregates. Fluorescence microscopy revealed that the interior regions of these structures consist primarily of voids or buffer-filled spaces that are depleted in micelles and polymers. These voids are surrounded by the matrix enriched in micelle-polymer complexes. At this stage, the network formed by interacting micelles and polymer chains is expected to be more compact, as a greater number of micelles associate with polymers, potentially acting as cross-linkers and increasing the connectivity of the network. Without wishing to be bound by theory, the formation of voids within these gel-phase droplets results from the release of counterions and water molecules during micelle-polymer association⁵⁵. As the micelle-polymer network becomes denser, the released counterions and water molecules can become trapped within the matrix, leading to the formation of internal voids. In the gel regime, contact angles measured from micelle-polymer complexes remain lower than those observed for micelle solutions alone, but progressively increase compared to those in the coacervate phase. This behaviour can result from surfactant molecules being more tightly bound within the denser network, limiting their availability to adsorb at the surface and promote spreading. Another notable observation in the gel phase is that the contact angle on hydrophobic surfaces becomes larger than that on hydrophilic surfaces. This is opposite to the trend seen in the coacervate regime. Such difference highlights the distinct interfacial properties of coacervates relative to other states formed by the same components. The unique mesoscale organization of the coacervate phase likely underlies its enhanced spreading behaviour.

As the titration progressed and the system entered the precipitation region, precipitate particles began to form. At this stage, the samples deposited for contact angle measurements contained both precipitates (FIGS. 11 and 12) and excess free micelles that were no longer interacting with PDADMAC. The measured contact angles began to resemble those of the micelle solution alone, on both hydrophilic and hydrophobic surfaces. Without wishing to be bound by theory, this occurred because the precipitates remained as suspended large flocs rather than forming a continuous film on the surface. As a result, the free micelles were primarily responsible for the surface interactions and thus governed the measured contact angle.

Overall, this study began by investigating the effect of micelle composition on the charge and structure of micelles, their subsequent interactions with polymers, and the resulting changes in the phase boundary observed during DICC. The results indicate that stronger interactions between micelles and polymers promote the expansion of the coacervation window during iso-ionic dilution. However, if the interactions become too strong, they can lead to precipitation rather than coacervation⁵⁵. Motivated by the unusual adhesive behaviour exhibited by the micelle-polymer coacervates on various materials (FIGS. 7A and 7B), we subsequently examined their wetting behaviour on both hydrophilic and rough hydrophobic surfaces. The coacervates exhibited superior spreading compared to micelle solutions alone. We attribute this enhanced wetting to the network structure of the coacervates, which, without wishing to be bound by theory, facilitates the coordinated delivery of surfactant molecules to the surface, rather than allowing them to diffuse freely in solution. This work represents an initial step in a broader effort to understand the interfacial behaviour of complex coacervates at solid-liquid interfaces.

### Non-Limiting Conclusions

In this study, we explored the phase behavior and interfacial properties of a mixed surfactant micelle-polymer system comprising SDS/LA65N micelles and PDADMAC. We demonstrate that micelle composition, particularly the fraction of ionic surfactant, critically influences micelle conformation and surface charge, thereby modulating phase transitions from soluble complexes to coacervates and ultimately to precipitates. Under iso-ionic dilution, we observed dilution-induced complex coacervation (DICC), with the extent of the coacervation region tunable by micelle charge and polymer-to-surfactant stoichiometry. These findings provide a framework for designing responsive delivery systems based on micelle-polymer coacervates. Notably, the coacervates exhibited enhanced wetting on both hydrophilic and hydrophobic surfaces, due to the presence of surfactants. However, they displayed superior spreading behavior compared to pure micelle solutions, particularly on rough hydrophobic surfaces. We attribute this to the hierarchical architecture of complex coacervates, in which micelles and polymers assemble into interconnected network structures. These networks can facilitate cooperative surfactant adsorption onto hydrophobic substrates with microstructured topography. In addition, the high local concentration of micelles within the coacervate phase further promotes the collapse of droplets into the Wenzel state, thereby enhancing wetting efficiency. Together, these results highlight the potential of micelle-polymer complex coacervates as tunable, stimuli-responsive materials for surface coating applications, particularly on hydrophobic substrates with nano or microscale structures.

### REFERENCES

1. Kizilay, E.; Maccarrone, S.; Foun, E.; Dinsmore, A. D.; Dubin, P. L., Cluster formation in polyelectrolyte-micelle complex coacervation. J Phys Chem B 2011, 115 (22), 7256-63.
2. Burton, Z.; Bhushan, B., Surface characterization and adhesion and friction properties of hydrophobic leaf surfaces. Ultramicroscopy 2006, 106 (8-9), 709-19.
3. Porcel, C. H.; Schlenoff, J. B., Compact polyelectrolyte complexes: “saloplastic” candidates for biomaterials. Biomacromolecules 2009, 10 (11), 2968-75.
4. Zhao, M.; Xia, X.; Mao, J.; Wang, C.; Dawadi, M. B.; Modarelli, D. A.; Zacharia, N. S., Composition and property tunable ternary coacervate: branched polyethylenimine and a binary mixture of a strong and weak polyelectrolyte. Molecular Systems Design & Engineering 2019, 4 (1), 110-121.
5. Kwant, A. N.; Es Sayed, J. S.; Kamperman, M.; Burgess, J. K.; Slebos, D. J.; Pouwels, S. D., Sticky Science: Using Complex Coacervate Adhesives for Biomedical Applications. Advanced healthcare materials 2025, 14 (2), 2402340.
6. Lankalapalli, S.; Kolapalli, V. R., Polyelectrolyte Complexes: A Review of their Applicability in Drug Delivery Technology. Indian J Pharm Sci 2009, 71 (5), 481-7.
7. Meka, V. S.; Sing, M. K. G.; Pichika, M. R.; Nali, S. R.; Kolapalli, V. R. M.; Kesharwani, P., A comprehensive review on polyelectrolyte complexes. Drug Discov Today 2017, 22 (11), 1697-1706.
8. Sim, B.; Chang, J. J.; Lin, Q.; Wong, J. H. M.; Ow, V.; Leow, Y.; Wong Y. J.; Boo Y. J.; Goh, R.; Loh, X. J., Hydrogels Based on Polyelectrolyte Complexes: Underlying Principles and; Gohdical Applications. Biomacromolecules 2024, 25 (12), 7563-7580.
9. Wang, Y.; Kimura, K.; Dubin, P. L.; Jaeger, W., Polyelectrolyte-micelle coacervation: Effects of micelle surface charge density, polymer molecular weight, and polymer/surfactant ratio. Macromolecules 2000, 33 (9), 3324-3331.
10. Tang, J. D.; Caliari, S. R.; Lampe, K. J., Temperature-dependent complex coacervation of engineered elastin-like polypeptide and hyaluronic acid polyelectrolytes. Biomacromolecules 2018, 19 (10), 3925-3935.
11. Nilsson, P.; Unga, J.; Hansson, P., Effect of salt and surfactant concentration on the structure of polyacrylate gel/surfactant complexes. The Journal of Physical Chemistry B 2007, 111 (37), 10959-10964.
12. Xu, A. Y.; Kizilay, E.; Madro, S. P.; Vadenais, J. Z.; McDonald K. W.; Dubin, P. L., Dilution induced coacervation in polyelectrolyte-micelle and polyelectrolyte-protein systems. Soft Matter 2018, 14 (12), 2391-2399.
13. Miyake, M., Recent progress of the characterization of oppositely charged polymer/surfactant complex in dilution deposition system. Advances in Colloid and Interface Science 2017, 239, 146-157.
14. Puente-Santamaría, A.; Monge-Corredor, J.; Ortega, F.; Rubio, R. G.; Guzmán, E., Dilution-controlled deposition of mixtures of a synthetic polycation and a natural origin polyelectrolyte with anionic surfactants on negatively charged surfaces. Colloids and Surfaces A: Physicochemical and Engineering Aspects 2024, 685, 133137.
15. Park, U.; Lee, M. S.; Jeon, J.; Lee, S.; Hwang, M. P.; Wang, Y.; Yang, H. S.; Kim, K., Coacervate-mediated exogenous growth factor delivery for scarless skin regeneration. Acta Biomaterialia 2019, 90, 179-191.
16. Svensson, M.; Linse, P.; Tjerneld, F., Phase Behavior in Aqueous Two-Phase Systems Containing Micelle-Forming Block Copolymers. Macromolecules 1995, 28 (10), 3597-3603.
17. Piculell, L., Understanding and Exploiting the Phase Behavior of Mixtures of Oppositely Charged Polymers and Surfactants in Water. Langmuir 2013, 29 (33), 10313-10329.
18. Jain, N.; Trabelsi, S.; Guillot, S.; McLouglilin, D.; Langevin D.; Letellier, P.; Turmine, M., Critical aggregation concentration in mixed solutions of anionic polyelectrolytes and cationic surfactants. Langmuir 2004, 20 (20), 8496-8503.
19. Pathak, J.; Priyadarshini, E.; Rawat, K.; Bohidar, H. B., Complex coacervation in charge complementary biopolymers: Electrostatic versus surface patch binding. Advances in Colloid and Interface Science 2017, 250, 40-53.
20. Chollakup, R.; Beck, J. B.; Dirnberger, K.; Tirrell, M.; Eisenbach, C. D., Polyelectrolyte Molecular Weight and Salt Effects on the Phase Behavior and Coacervation of Aqueous Solutions of Poly(acrylic acid) Sodium Salt and Poly(allylamine) Hydrochloride. Macromolecules 2013, 46 (6), 2376-2390.
21. Fan, Y. X.; Kellermeier, M.; Xu, A. Y.; Boyko, V.; Mirtschin, S.; Dubin, P. L., Modulation of Polyelectrolyte Micelle Interactions via Zeta Potentials. Macromolecules 2017, 50 (14), 5518-5526.
22. Stewart, R. J.; Wang, C. S.; Shao, H., Complex coacervates as a foundation for synthetic underwater adhesives. Advances in Colloid and Interface Science 2011, 167 (1), 85-93.
23. Dompé, M.; Cedano-Serrano, F. J.; Heckert, O.; van den Heuvel, N.; van der Gucht, J.; Tran, Y.; Hourdet, D.; Creton, C.; Kamperman, M., Thermoresponsive Complex Coacervate-Based Underwater Adhesive. Advanced Materials 2019, 31 (21), 1808179.
24. Kwant, A. N.; Es Sayed, J. S.; Kamperman, M.; Burgess, J. K.; Slebos, D. J.; Pouwels, S. D., Sticky Science: Using Complex Coacervate Adhesives for Biomedical Applications. Adv Healthc Mater 2025, 14 (2), e2402340.
25. Maan, A. M. C.; Graafsma, C. N.; Hofman, A. H.; Pelras, T.; deVos, W. M.; Kamperman, M., Scalable Fabrication of Reversible Antifouling Block Copolymer Coatings via Adsorption Strategies. ACS Appl Mater Interfaces 2023, 15 (15), 19682-19694.
26. Kurtz, I. S.; Sui, S.; Hao, X.; Huang, M.; Perry, S. L.; Schiffman, J. D., Bacteria-Resistant, Transparent, Free-Standing Films Prepared from Complex Coacervates. ACS Appl Bio Mater 2019, 2 (9), 3926-3933.
27. Zhao, X.; Wang, L.; Gao, J.; Chen, X.; Wang, K., Hyaluronic acid/lysozyme self-assembled coacervate to promote cutaneous wound healing. Biomater Sci 2020, 8 (6), 1702-1710.
28. Kim, B.; Ban, E.; Kim, A., Gelatin-Alginate Coacervates Optimized by DOE to Improve Delivery of bFGF for Wound Healing. Pharmaceutics 2021, 13 (12).
29. Peng, X.; Li, Y.; Li, T.; Li, Y.; Deng, Y.; Xie, X.; Wang, Y.; Li, G.; Bian, L., Coacervate-Derived Hydrogel with Effective Water Repulsion and Robust Underwater Bioadhesion Promotes Wound Healing. Adv Sci (Weinh) 2022, 9 (31), e2203890.
30. Zhang, L.; Wang, J.; Fan, Y.; Wang, Y., Coacervate-Enhanced Deposition of Sprayed Pesticide on Hydrophobic/Superhydrophobic Abaxial Leaf Surfaces. Adv Sci (Weinh) 2023, 10 (18), e2300270.
31. Liu, B.; Fan, Y.; Li, H.; Zhao, W.; Luo, S.; Wang, H.; Guan, B.; Li, Q.; Yue, J.; Dong, Z.; Wang, Y.; Jiang, L., Control the Entire Journey of Pesticide Application on Superhydrophobic Plant Surface by Dynamic Covalent Trimeric Surfactant Coacervation. Advanced Functional Materials 2021, 31 (5), 2006606.
32. Wang, J.; Fan, Y.; Wang, H.; Yin, J.; Tan, W.; Li, X.; Shen, Y.; Wang, Y., Promoting efficacy and environmental safety of photosensitive agrochemical stabilizer via lignin/surfactant coacervates. Chemical Engineering Journal 2022, 430, 132920.
33. Josyula, T.; Malla, L. K.; Thomas, T. M.; Kalichetty, S. S.; Mahapatra, P. S.; Pattamatta, A., Fundamentals and Applications of Surface Wetting. Langmuir 2024, 40 (16), 8293-8326.
34. Peethan, A.; Lawrence, J.; GeorGe, S., Wettability contrast surfaces: Fabrication and applications. Int J Wettability Sci Technol 2020, 1, 189-219.
35. Catterton, M. A.; Montalbine, A. N.; Pompano, R. R., Selective Fluorination of the Surface of Polymeric Materials after Stereolithography 3D Printing. Langmuir 2021, 37 (24), 7341-7348.
36. Nambafu, G. S.; Kim, N.; Kim, J., Hydrophobic coatings prepared using various dipodal silane-functionalized polymer precursors. Applied Surface Science Advances 2022, 7, 100207.
37. ten Brink, G. H.; Foley, N.; Zwaan, D.; Kooi, B. J.; Palasantzas, G., Roughness controlled superhydrophobicity on single nanometer length scale with metal nanoparticles. RSC Advances 2015, 5 (36), 28696-28702.
38. Wang, J.; Liu, M.; Ma, R.; Wang, Q.; Jiang, L., In situ wetting state transition on micro- and nanostructured surfaces at high temperature. ACS Appl Mater Interfaces 2014, 6 (17), 15198-208.
39. Law, K.-Y., Definitions for Hydrophilicity, Hydrophobicity, and Superhydrophobicity: Getting the Basics Right. The Journal of Physical Chemistry Letters 2014, 5 (4), 686-688.
40. Bayer, I. S., Superhydrophobic Coatings from Ecofriendly Materials and Processes: A Review. Advanced Materials Interfaces 2020, 7 (13), 2000095.
41. Wenzel, R. N., Resistance of solid surfaces to wetting by water. Industrial & engineering chemistry 1936, 28 (8), 988-994.
42. Cassie, A.; Baxter, S., Wettability of porous surfaces. Transactions of the Faraday society 1944, 40, 546-551.
43. Heller, W. T.; Hetrick, J.; Bilheux, J.; Calvo, J. M. B.; Chen, W.-R.; DeBeer-Schmitt, L.; Do, C.; Doucet, M.; Fitzsimmons, M. R.; Godoy, W. F.; Granroth, G. E.; Hahn, S.; He, L.; Islam, F.; Lin, J.; Littrell, K. C.; McDonnell, M.; McGaha, J.; Peterson, P. F.; Pingali, S. V.; Qian, S.; Savici, A. T.; Shang, Y.; Stanley, C. B.; Urban, V. S.; Whitfield, R. E.; Zhang, C.; Zhou, W.; Billings, J. J.; Cuneo, M. J.; Leal, R. M. F.; Wang, T.; Wu, B., drtsans: The data reduction toolkit for small-angle neutron scattering at Oak Ridge National Laboratory. SoftwareX 2022, 19.
44. Manalastas-Cantos, K.; Konarev, P. V.; Hajizadeh, N. R.; Kikhney, A. G.; Petoukhov, M. V.; Molodenskiy, D. S.; Panjkovich, A.; Mertens, H. D. T.; Gruzinov, A.; Borges, C.; Jeffries, C. M.; Svergun, D. I.; Franke, D., ATSAS 3.0: expanded functionality and new tools for small-angle scattering data analysis. J Appl Crystallogr 2021, 54 (Pt 1), 343-355.
45. Kline, S. R., Reduction and analysis of SANS and USANS data using IGOR Pro. Journal of Applied Crystallography 2006, 39 (6), 895-900.
46. Pedersen, J. S.; Schurtenberger, P., Scattering Functions of Semiflexible Polymers with and without Excluded Volume Effects. Macromolecules 1996, 29 (23), 7602-7612.
47. Chen, W.-R.; Butler, P. D.; Magid, L. J., Incorporating Intermicellar Interactions in the Fitting of SANS Data from Cationic Wormlike Micelles. Langmuir 2006, 22 (15), 6539-6548.
48. McDowall, D.; Adams, D. J.; Seddon, A. M., Using small angle scattering to understand low molecular weight gels. Soft Matter 2022, 18 (8), 1577-1590.
49. Larsson, J.; Sanchez-Fernandez, A.; Mahmoudi, N.; Barnsley, L. C.; Wahlgren, M.; Nylander, T.; Ulvenlund, S., Effect of the Anomeric Configuration on the Micellization of Hexadecylmaltoside Surfactants. Langmuir 2019, 35 (43), 13904-13914.
50. Hassan, P.; Fritz, G.; Kaler, E. W., Small angle neutron scattering study of sodium dodecyl sulfate micellar growth driven by addition of a hydrotropic salt. Journal of colloid and interface science 2003, 257 (1), 154-162.
51. Artykulnyi, O. P.; Siposova, K.; Kriechbaum, M.; Musatov, A.; Almásy, L.; Petrenko, V., Micelle Formation in Aqueous Solutions of the Cholesterol-Based Detergent Chobimalt Studied by Small-Angle Scattering. Molecules 2023, 28 (4), 1811.
52. Bevington, P. R.; Robinson, D. K., Data reduction and error analysis. McGrawâ€ “Hill, New York 2003.
53. Wong, J. X. H.; Yu, H.-Z., Preparation of Transparent Superhydrophobic Glass Slides: Demonstration of Surface Chemistry Characteristics. Journal of Chemical Education 2013, 90 (9), 1203-1206.
54. Wong, J. X.; Yu, H.-Z., Preparation of transparent superhydrophobic glass slides: Demonstration of surface chemistry characteristics. Journal of Chemical Education 2013, 90 (9), 1203-1206.
55. Comert, F.; Nguyen, D.; Rushanan, M.; Milas, P.; Xu, A. Y.; Dubin, P. L., Precipitate-Coacervate Transformation in Polyelectrolyte-Mixed Micelle Systems. The Journal of Physical Chemistry B 2017, 121 (17), 4466-4473.
56. Xu, A. Y.; Melton, L. D.; Ryan, T. M.; Mata, J. P.; Rekas, A.; Williams, M. A.; McGillivray, D. J., Effects of polysaccharide charge pattern on the microstructures of β-lactoglobulin-pectin complex coacervates, studied by SAXS and SANS. Food Hydrocolloids 2018, 77, 952-963.
57. Xu, A. Y.; Melton, L. D.; Ryan, T. M.; Mata, J. P.; Jameson, G. B.; Rekas, A.; Williams, M. A.; McGillivray, D. J., Sugar-coated proteins: the importance of degree of polymerisation of oligo-galacturonic acid on protein binding and aggregation. Soft Matter 2017, 13 (14), 2698-2707.
58. Shardt, N.; Bigdeli, M. B.; Elliott, J. A. W.; Tsai, P. A., How Surfactants Affect Droplet Wetting on Hydrophobic Microstructures. The Journal of Physical Chemistry Letters 2019, 10 (23), 7510-7515.

### SANS Data Fitting

In this study, SANS measurements were performed to characterize the conformational transition of micelles with increasing Y values. To this end, scattering profiles measured from micelle samples were fitted using a model that considers micelles as flexible cylinders with cylinder radius polydispersity index. Structural parameters of the fit model are contour length, Kuhn length, mean cylinder cross section radius and radius polydispersity index. Our fitting results showed strong correlation between the Kuhn length and the contour length fit parameters and allowing both parameters to fit led to instability. To improve fitting stability, the Kuhn length was fixed to the average value of Kuhn length, 14 Å, determined by fitting the dataset with all structural parameters as fitting parameters. With the Kuhn length fixed, only the contour length was varied in subsequent analysis to ensure consistent and reliable fitting results. Fitting parameters used to fit the experimental data is shown in Table 1 below:

TABLE 1
Non-limiting exemplary fitting parameters of experimental
data described herein.

| Fit | | | | | |
|---|---|---|---|---|---|
| Parameter | Y = 0.25 | Y = 0.3 | Y = 0.35 | Y = 0.4 | Y = 0.5 |
| Length (Å) | 242.4 ± 4.5 | 206.7 ± 2.7 | 195.9 ± 2.5 | 181.7 ± 2.3 | 177.1 ± 2.4 |
| Kuhn length | 14 | 14 | 14 | 14 | 14 |
| (Å) | | | | | |
| Radius (Å) | 19.07 ± 0.14 | 19.04 ± 0.11 | 18.97 ± 0.1 | 18.50 ± 0.1 | 17.9 ± 0.1 |
| Polydispersity | 0.17 ± 0.03 | 0.18 ± 0.02 | 0.19 ± 0.02 | 0.19 ± 0.02 | 0.18 ± 0.02 |
| ratio of | | | | | |
| radius | | | | | |
| SLD of | 0.192 | 0.198 | 0.200 | 0.210 | 0.220 |
| micelles (10⁻⁶/ | | | | | |
| Å²) | | | | | |

### Microscopic Imaging

Type 2 titrations were conducted by first preparing SDS/LA65N micelles at a Y value of 0.4. These micelles were then gradually added into a PDADMAC solution. During the titration, the system progressed through several distinct phases: it initially formed complex coacervates, then developed gel-like structures exhibiting a ‘droplets-in-droplets’ morphology, and eventually produced irregularly shaped precipitates (FIG. 11). To track micelle distribution, we labelled the micelles with the fluorescent dye Nile Red. Fluorescence microscopy images were collected from samples at different titration stages. Bright-field microscopy allowed us to observe the overall morphology, while fluorescence imaging revealed the localization of micelles within the different phases (FIG. 12).

### Example 2

### Interfacial Behavior of Micelle-Polymer Complex Coacervates

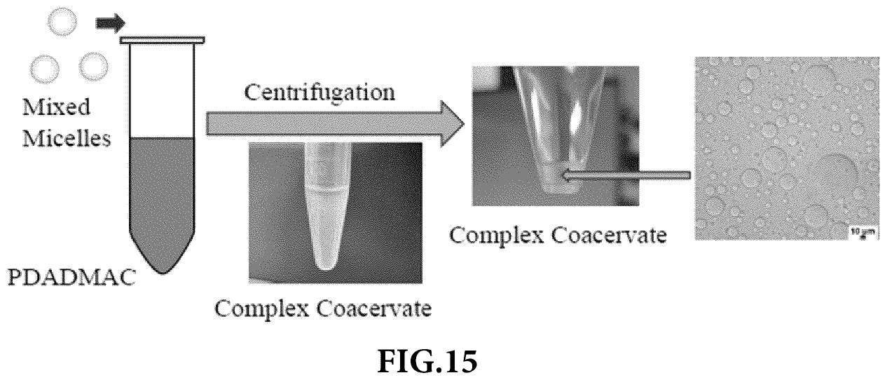

Complex coacervation is a form of liquid-liquid phase separation resulting from strong associative interaction among oppositely charged macromolecules. In this study, a model coacervate system was used containing non-ionic: anionic mixed surfactant micelle and a cationic polymer. FIG. 15 shows a non-limiting, exemplary illustration of a process for making complex coacervates.

When micelles and polymers are in high concentrations, phase separation is suppressed, so they remain as a clear single phase called the “suppressed phase.” Upon diluting with a diluent (e.g., 0.4 mM NaCl), the solution becomes turbid and forms two phases thereby producing complex coacervates. By diluting, we reduce the total macromolecular concentration. Below a critical concentration, the solution undergoes phase separation. This is dilution induced complex coacervation (DICC).

Complex coacervates are dynamic structures that can be influenced by many factors such as pH, ionic strength, temperature, as well as the total macromolecule concentration (C_{T}). Micelle-polyelectrolyte complexes are stabilized in a single-phase region (suppressed phase) at high C_{T} and then phase separate as coacervate liquid droplets upon iso-ionic dilution. Herein, the interfacial behavior of coacervates on different surfaces to advance application of DICC as a stimuli-responsive coating method was investigated.

### Materials and Methods

The polymer solution chosen in these experiments was poly(diallyldimethylammonium chloride) (PDADMAC), and the anionic:non-ionic mixed micelles comprised sodium dodecyl sulfate (SDS) and Lutensol A65N (LA60). The structures for PDADMAC, SDS, and LA60 are shown as:

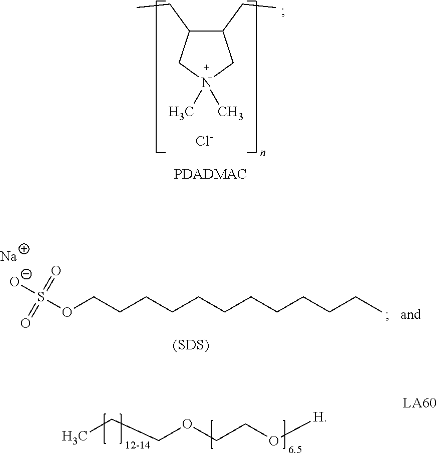

The mole fraction of SDS is represented as Y and it can be calculated using Eq. 1.

$$Y = \frac{[ SDS ]}{[ SDS ] + [ LA 65 N ]} \qquad Eq . 1$$

where [SDS] is the concentration of SDS, and [LA65N] is the concentration of LA65N. The mole fraction of SDS of Y=0.3 was used to prepare suppressed phase solutions using NaCl for the iso-ionic dilution experiments.

The four types of surfaces used in this experiment were hydrophobic glass surfaces, methyltrichlorosilane coated superhydrophobic surfaces (MTC-SHPB), polymethyl methacrylate coated hydrophobic surfaces (PMMA-HPB), and octadecyltrichlorosilnae coated hydrophobic surfaces (ODTC-HPB).

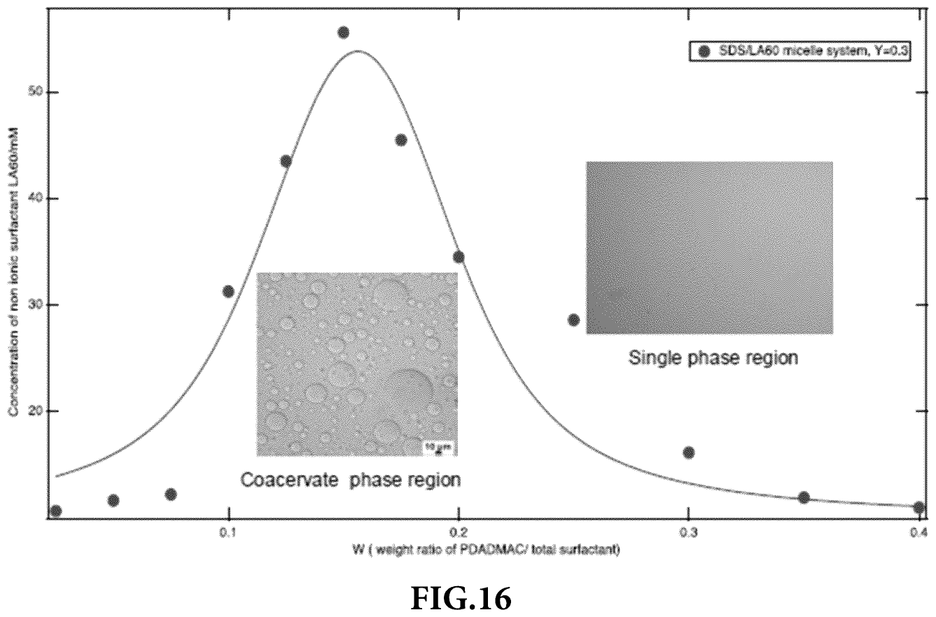

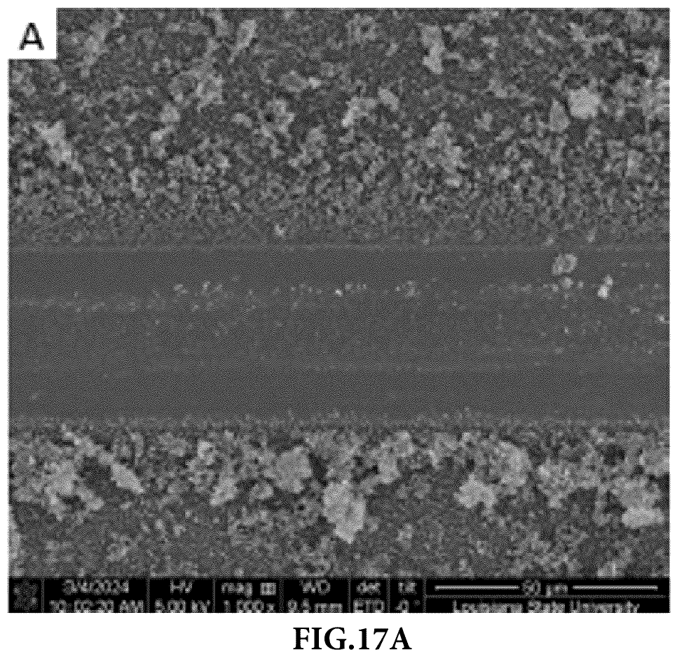

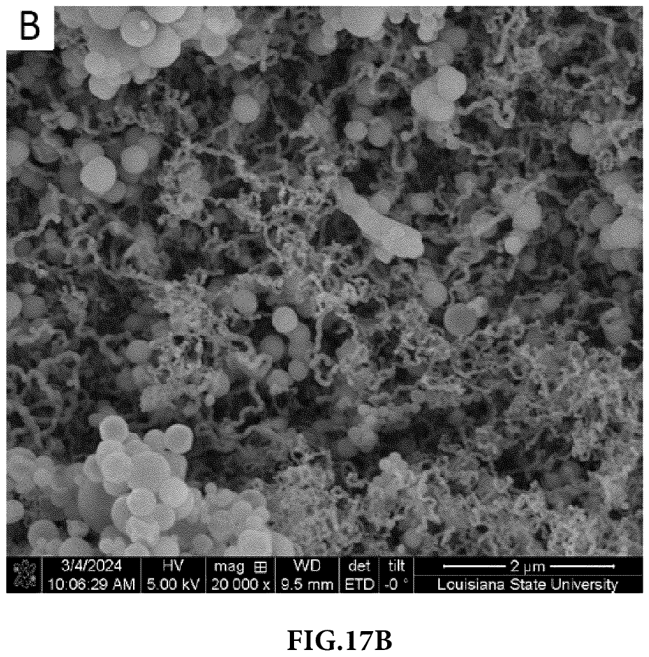

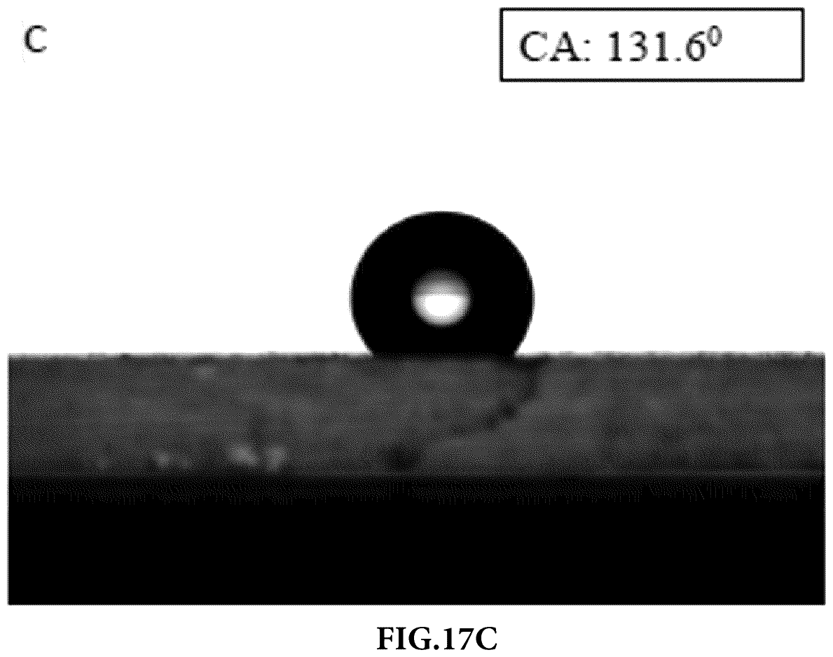

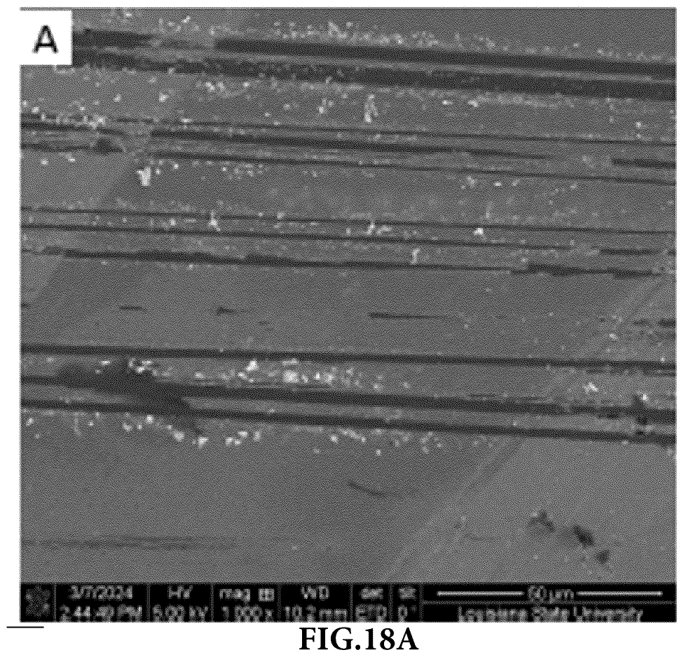

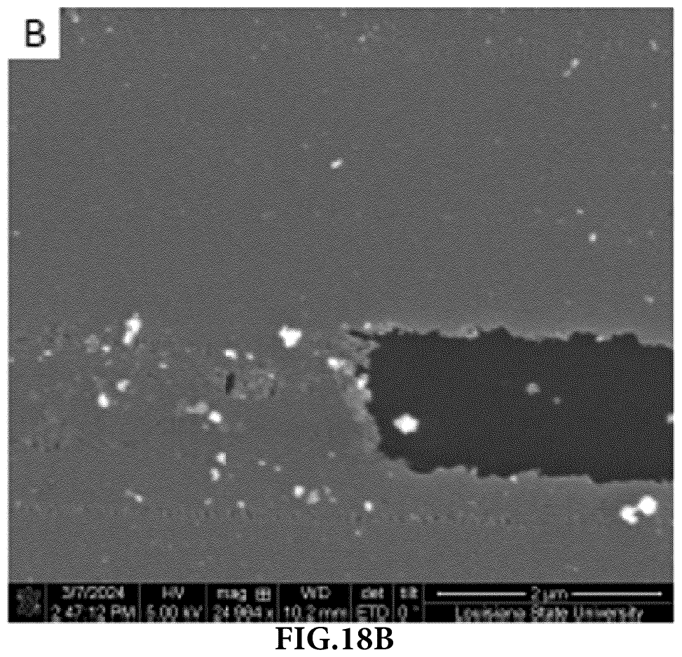

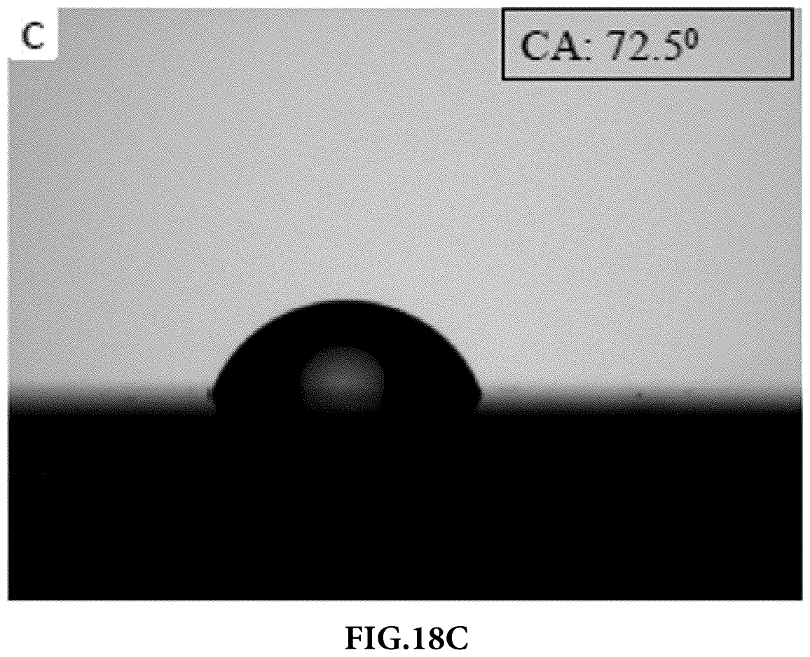

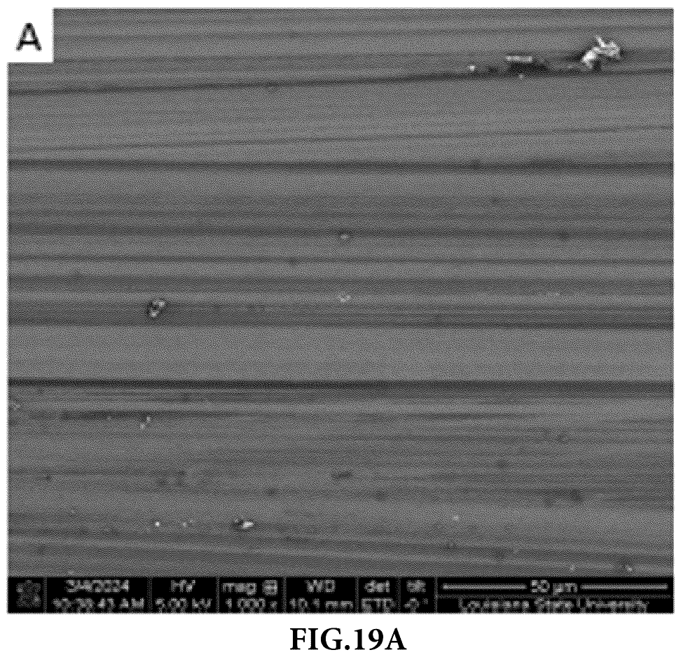

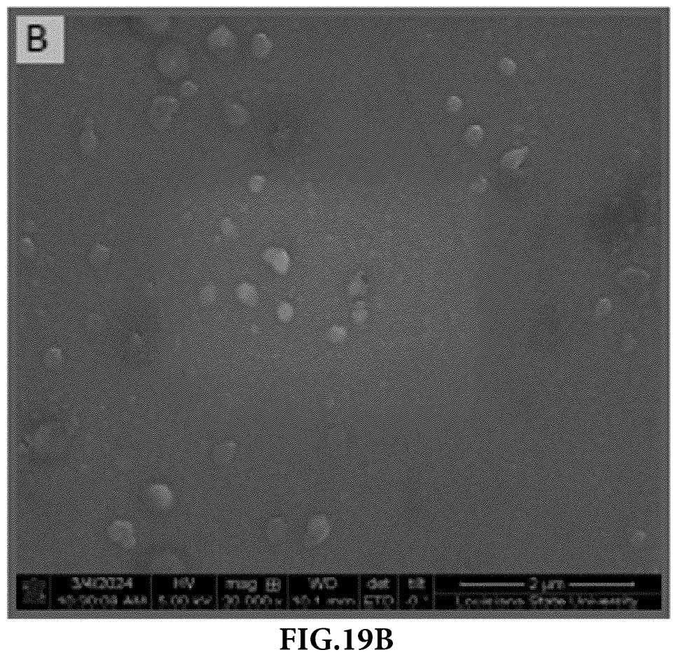

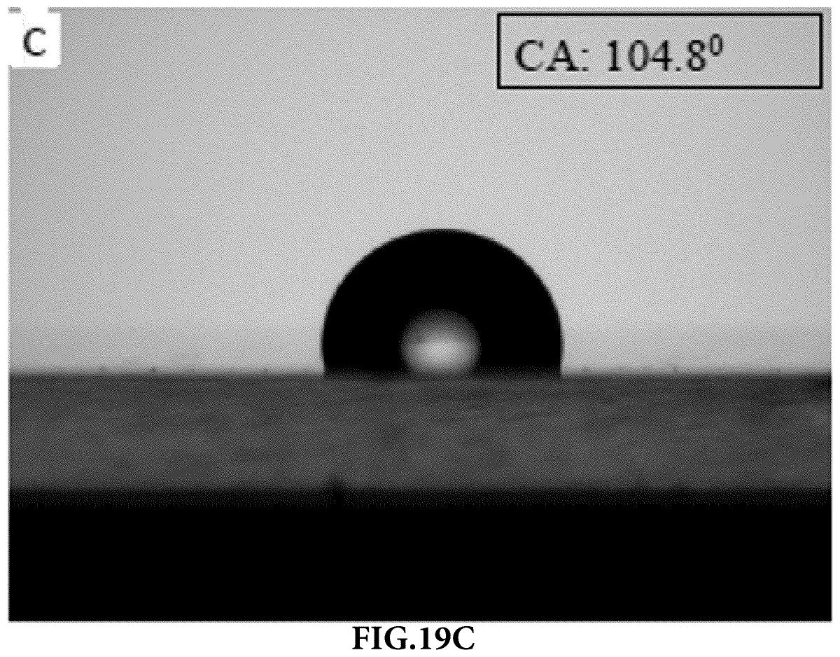

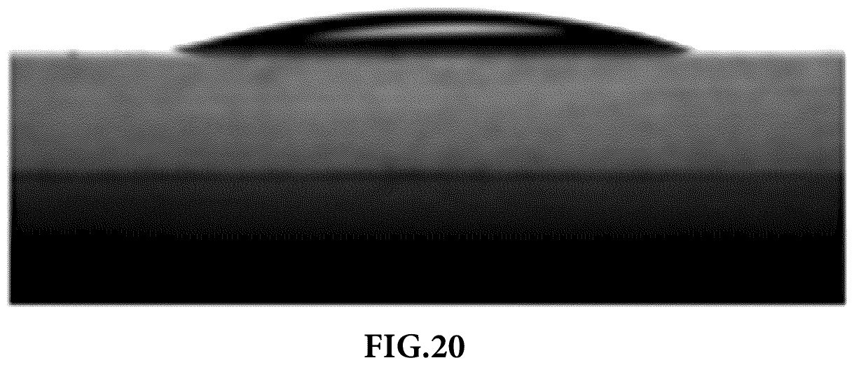

Phase boundaries of iso-ionic dilution for Y=0.3 SDS/LA60-PDADMAC system were determined and non-limiting, exemplary data are shown in FIG. 16. Contact angles were measured for suppressed phase dilution series on different surfaces. SEM microscopy images were captured of the four types of surfaces at 1000×, and 20,000× magnification (FIG. 17A-19C). Water droplet contact angle measurements were also performed on the four surfaces. FIG. 17C shows a non-limiting, exemplary contact angle measurement of a water droplet on a MTC-SHPB surface, with a measured contact angle of about 131.6°. FIG. 18C shows a non-limiting, exemplary contact angle measurement of a water droplet on a PMMA-HPB surface, with a measured contact angle of about 72.5°. FIG. 19C shows a non-limiting, exemplary contact angle measurement of a water droplet on ODTC-HPB surfaces, with a measured contact angle of about 72.5°. A cleaned microscopic glass surface was used without any deposition for the hydrophilic glass surface, and a water droplet contact angle was measured at about 17° (FIG. 20). Fluorescence Studies of coacervates deposited on different surfaces were conducted.

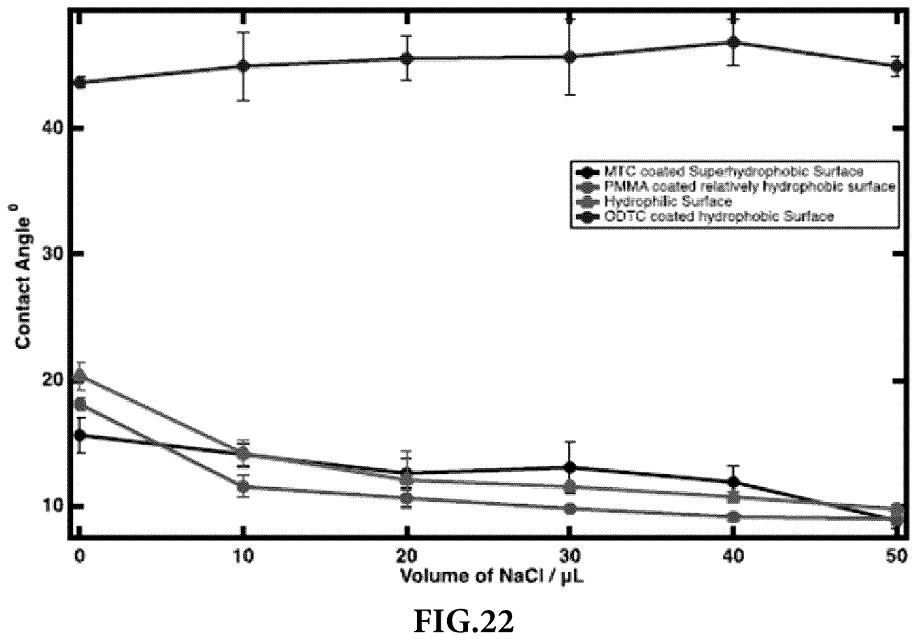

### Method in Experiment Described in FIG. 22

Method for the experiment in FIG. 22: The suppressed phase was prepared by concentrating micelles and polymers in one phase solution. Here Y is the anionic surfactant molar ratio in the SDS/LA65N mixed micelle and W is the weight ratio of polymers and mixed surfactants. In this experiment, Y=0.3 W=0.3 SDS/LA65N-PDADMAC. The suppressed phase solution was prepared by adding 36.1 mM of SDS, 83 mM of LA65N and 8.7 mg/ml of PDADMAC. The solution was mixed overnight. A concentrated one phase suppressed phase resulted. A series of 1.5 μL centrifuge tubes were filled with 10 μL of this Y=0.3, W=0.3 SDS/LA60-PDADMAC suppressed phase. To the first tube, 10 μL of NaCl (0.4M) was added and mixed. Likewise the following series was prepared: 1. Suppressed phase, 2. Suppressed phase 10 μL+NaCl 10 μL, 3. Suppressed phase 10 μL+NaCl 20 μL, 4. Suppressed phase 10 μL+NaCl 30 μL, 5. Suppressed phase 10 μL+NaCl 40 μL, 6. Suppressed phase 10 μL+NaCl 50 μL. Coacervates were formed from 2nd sample. From sample 1, 3 μL was dropped on the surface and let spread for 30 seconds. Contact angle was measured at 30 second time interval. Then from the sample 2, 3 μL was dropped on the surface and let spread for 30 seconds. Contact angle was measured at 30 second time interval. This was repeated 3 times. Likewise, above same procedure was repeated to all the other samples. The procedure was repeated for all the surfaces: hydrophilic surface, ODTC-HPB, MTC-SHPB and PMMA surface. The experiment, methods, and concentrations were different from some embodiments of methods and results described herein (e.g., in Example 1).

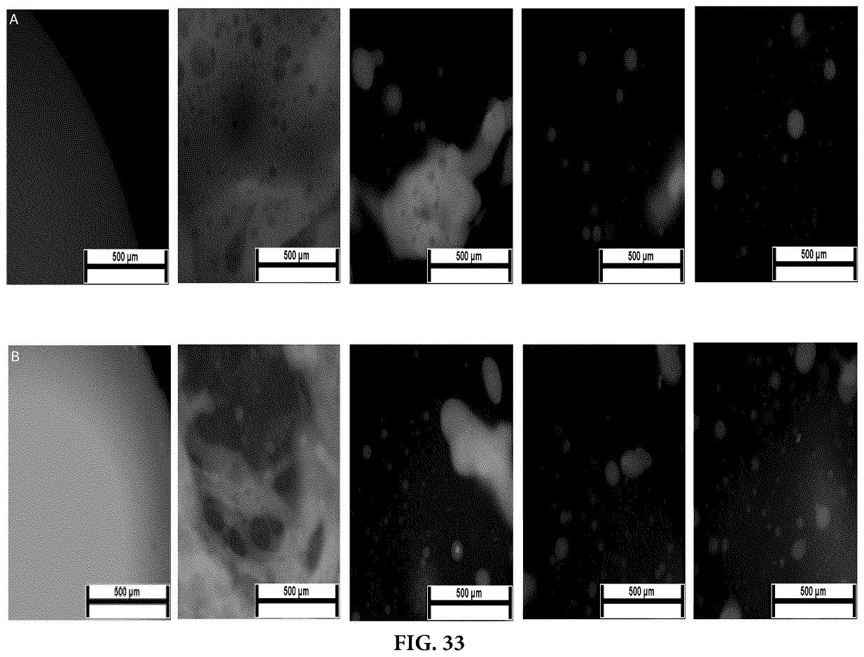

### Method Described in FIG. 33

FIG. 33 describes additional experiments. As explained in “Method for the experiment in FIG. 22,” we performed a DICC on another suppressed phase, Y=0.45 W=0.3 SDS/LA65N-PDADMAC system. Similarly, a dilution series was prepared by diluting each 200 μL of Y=0.45 W=0.3 suppressed phase with 200 μL, 500 μL, 800 μL, 1000 μL and 1500 μL of NaCl in separate centrifuge tubes. They were mixed and aliquots of each coacervate mixture was dropped on the hydrophilic and MTC-SHPB surfaces separately and observed under fluorescence microscope to get fluorescence imaging. When diluting, viscous suppressed phase turned into gel like phase and it forms structures that has buffer entrapped in it. With more dilutions, coacervates starts to form and circular or irregular shaped coacervate droplets starts to deposit on the surfaces.

We used Nile Red as a payload and a fluorescence probe. Micelles were loaded with Nile Red, when the suppressed phase (a highly concentrated one phase solution) was prepared. Micelles could be seen throughout the suppressed phase when observed under the fluorescence microscope. Upon dilution, the one phase system underwent phase separation and forms gels first and eventually coacervates droplets. This data indicates that the payload can be concentrated first in the suppressed phase and when diluting the payload can migrate into the forming coacervates, and then spread on the surface.

### Non-Limiting, Exemplary Results and Discussion

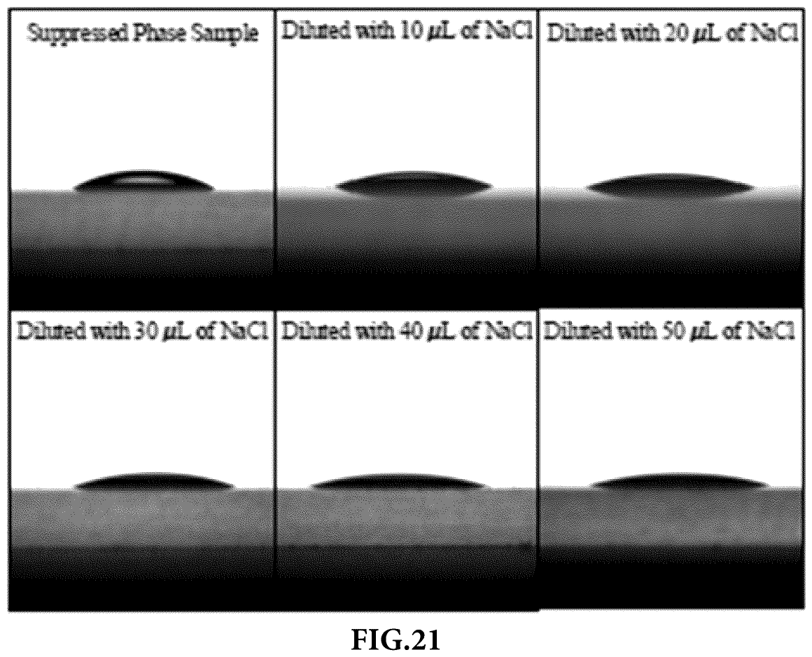

Coacervates carry both hydrophilic and hydrophobic components. Upon dilution of suppressed phase, phase separation occurs, forming complex coacervate droplets. These coacervate droplets can spread on both hydrophilic and hydrophobic type surfaces. This can be confirmed by contact angle measurements (FIG. 21-22).

Regarding the experiments described in FIG. 22, the experiment, methods, and concentrations were different from some embodiments of methods and results described herein (e.g., in Example 1). For example, in other embodiments of the disclosure, a Type 2 titration was the main method (i.e., we systematically titrated micelles into polymers and measured the contact angles at different stoichiometries, where the phase transitions were observed from soluble complexes to coacervates to gels to precipitates). Those Type 2 experiments indicated that the coacervates spread more on superhydrophobic/rough hydrophobic surfaces compared to hydrophilic surfaces. The concentrations range used in the Type 2 experiment were (for Y=0.4 SDS/LA65N micelles) SDS (1.176 mM-30 mM), LA65N (1.764 mM-45 mM) and PDADMAC concentration was 1.5 mg/mL (see e.g., FIGS. 9A and 9B).

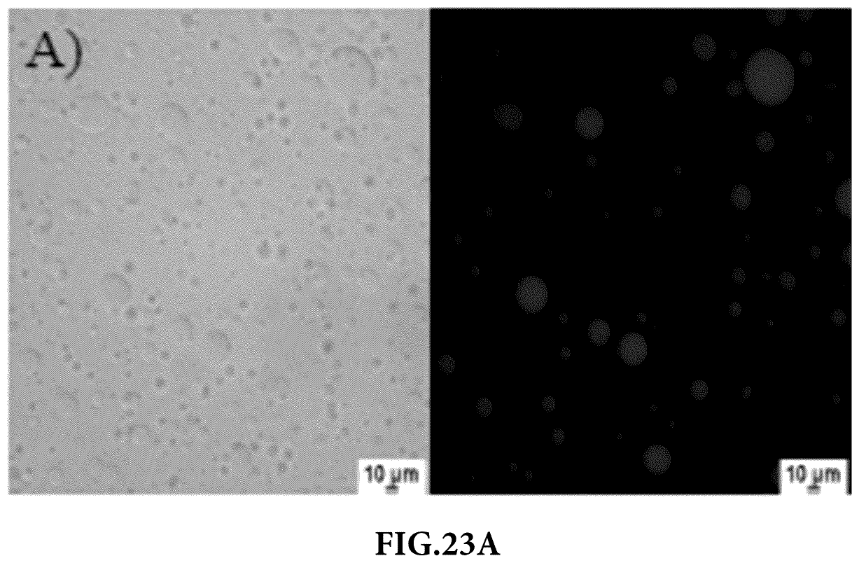

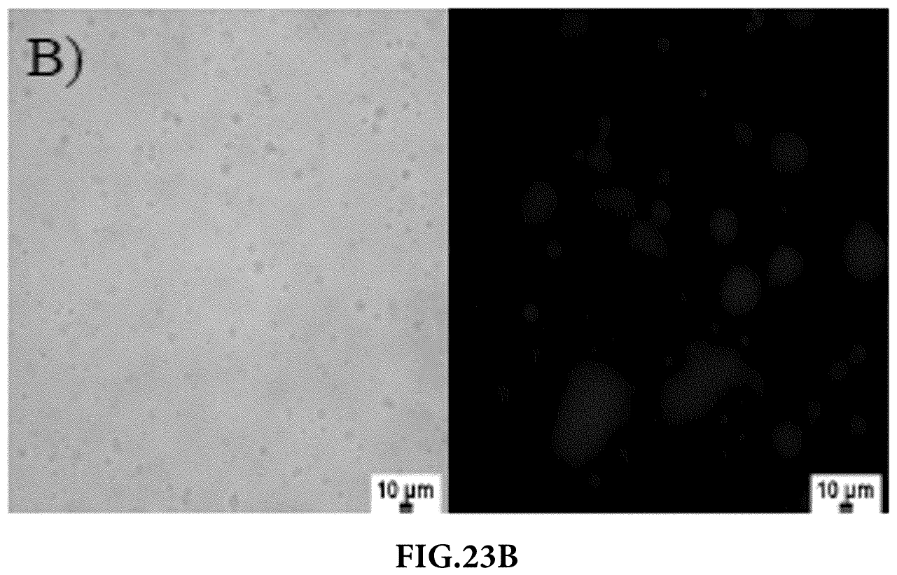

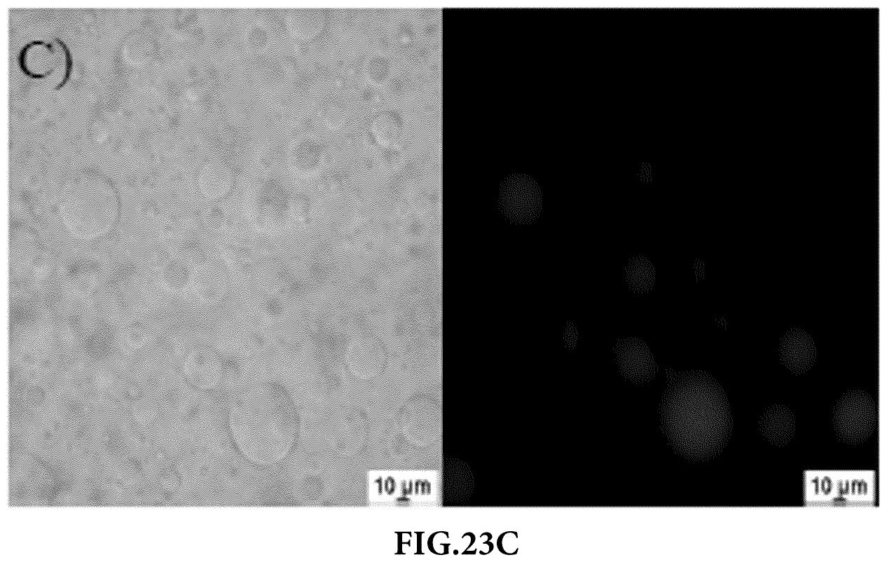

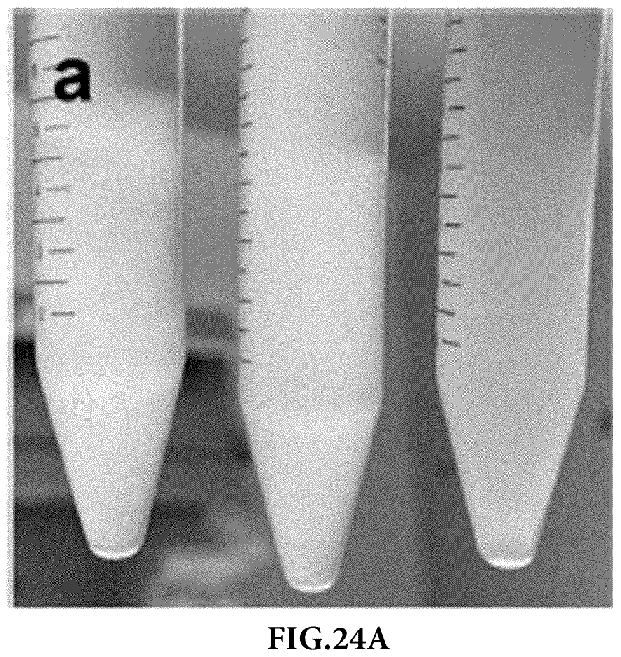

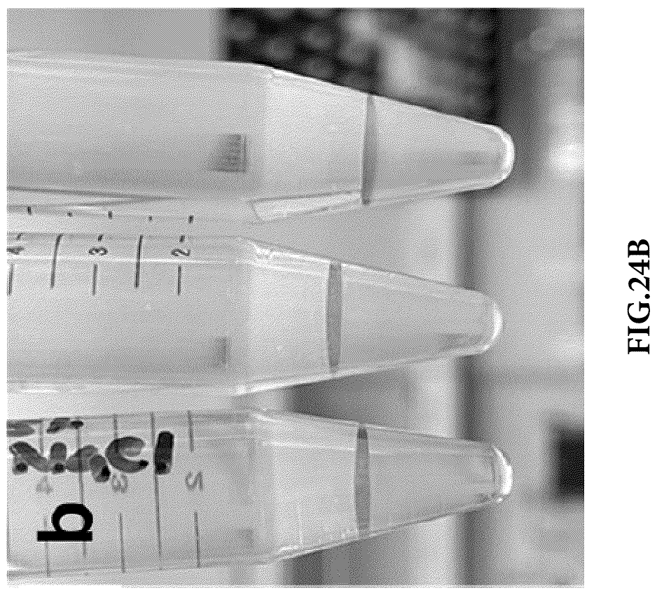

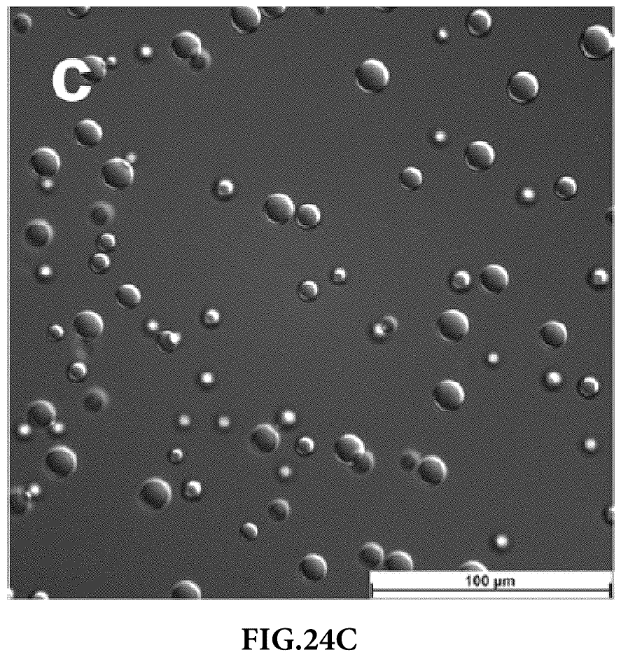

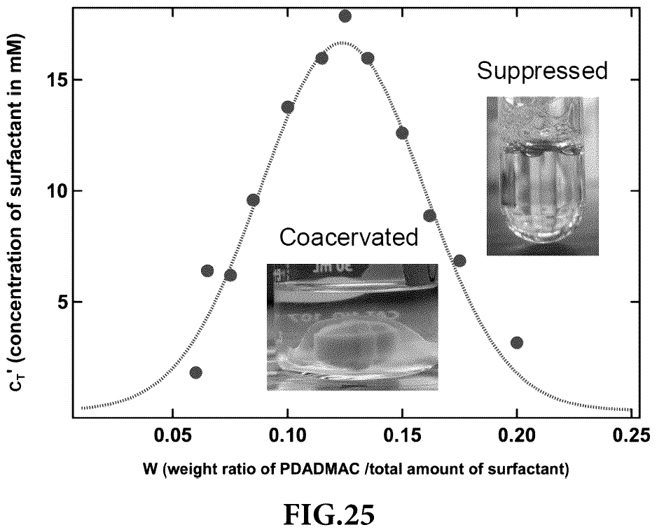

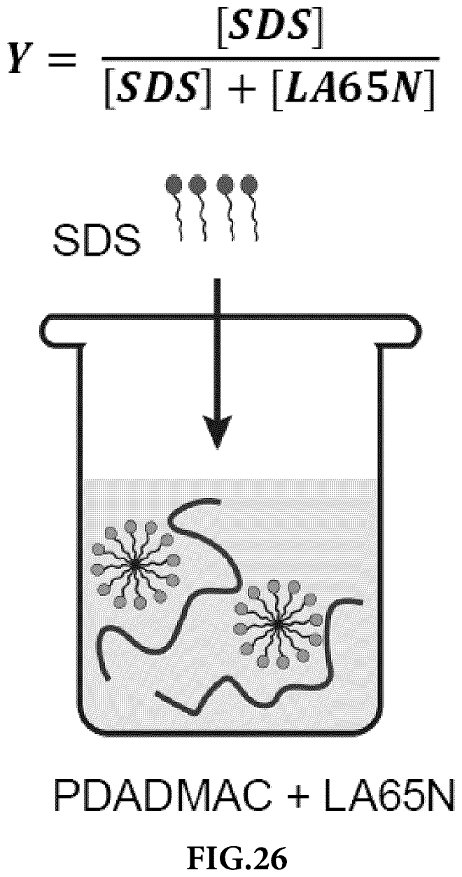

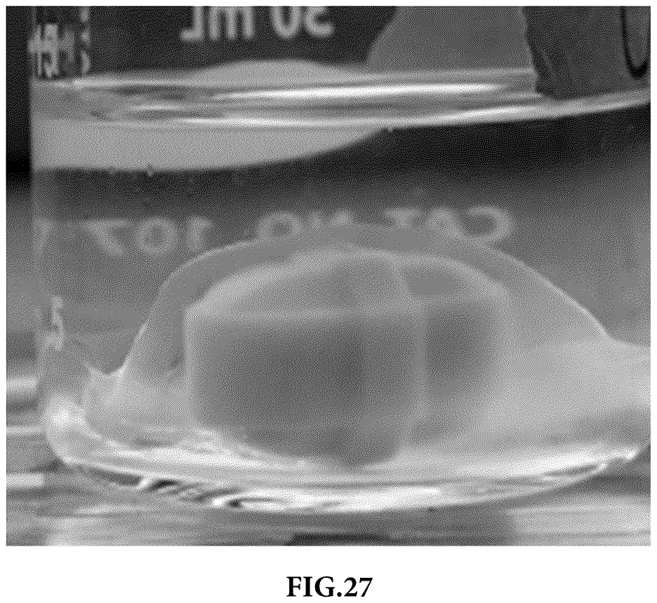

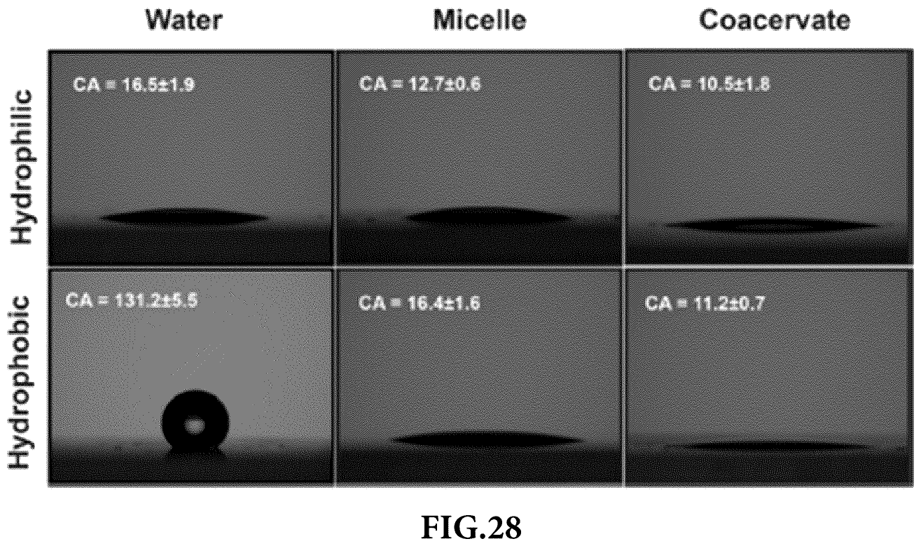

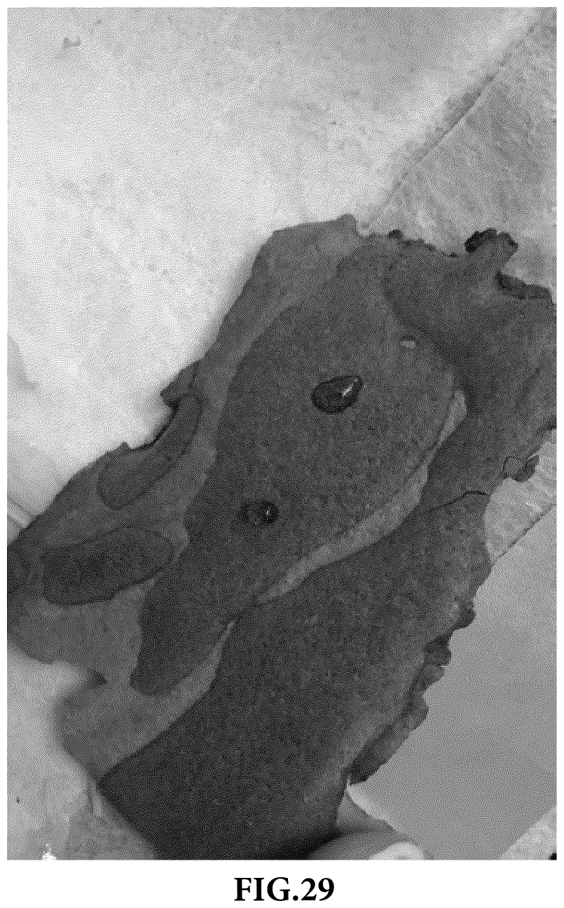

Fluorescence studies were carried out by probing micelles with Nile Red, a hydrophobic dye. The dyed coacervates were deposited on different surfaces and the deposition patterns were observed. Non-limiting, exemplary images of these deposition patterns are shown in FIGS. 23A-23C.

### Non-Limiting, Exemplary Conclusions

Iso-ionic dilution causes phase separation and complex coavercate formation, which then can be successfully deposited on varying hydrophobic and hydrophilic surfaces. Decreasing patterns of contact angles indicates that more dilution causes more coacervate formation systematically and the spreading increases accordingly. This indicates increased wettability. Coacervates can spread more on hydrophilic, MTC coated superhydrophobic, and PMMA coated hydrophobic surfaces. Fluorescence studies give visual observation of how coacervate droplets deposit on varying surfaces. Coacervates form circular deposits on hydrophilic surfaces, and circular and irregular shaped deposits on hydrophobic type surfaces.

References used herein:
Xu A Y, Kizilay E, Madro S P, Vadenais J Z, McDonald K W, Dubin P L. Dilution induced coacervation in polyelectrolyte-micelle and polyelectrolyte-protein systems. Soft Matter. 2018 Mar. 28; 14 (12): 2391-2399. doi: 10.1039/c7sm02293j. Epub 2018 Mar. 5. PMID: 29503995.
Wong, J. X. H., & Yu, H.-Z. (2013). Preparation of Transparent Superhydrophobic Glass Slides: Demonstration of Surface Chemistry Characteristics. Journal of Chemical Education, 90 (9), 1203-1206. doi: 10.1021/ed300809m.
Akers, P. W., Nelson, A. R. J., Williams, D. E., & McGillivray, D. J. (2015). Formation of hydrated layers in PMMA thin films in aqueous solution. Applied Surface Science, 353, 829-834. doi: 10.1016/j.apsusc.2015.06.1.

### Example 3

### Non-limiting, Exemplary Tunable Phase Separation and Interfacial Behaviour of Mixed Surfactant Micelle-Polymer Complex Coacervates

In this study, SANS measurements were performed to characterize the conformational transition of micelles with increasing Y values. To this end, scattering profiles measured from micelle samples were fitted using a model that considers micelles as flexible cylinders with cylinder radius polydispersity index. Structural parameters of the fit model are contour length, Kuhn length, mean cylinder cross section radius and radius polydispersity index. Our fitting results indicated strong correlation between the Kuhn length and the contour length fit parameters and allowing both parameters to fit led to instability. To improve fitting stability, the Kuhn length was fixed to the average value of Kuhn length, 14 Å, determined by fitting the dataset with all structural parameters as fitting parameters. With the Kuhn length fixed, only the contour length was varied in subsequent analysis to ensure consistent and reliable fitting results. Fitting parameters used to fit the experimental data is shown in Table 1.

### Example 4

### Dilution-Induced Complex Coacervation as a Delivery Strategy for Agricultural Products

### Non-Limiting, Exemplary Loading Procedure

In embodiments of the current disclosure, the micelle and polymer complexes will be prepared at high concentration, beyond the critical total macromolecular concentration (C_{T}′), where the complex coacervation process is inhibited. To prepare the concentrated sample, micelle, polymer and payload molecules are mixed together at high concentrations, at this stage, the samples remain in a single suppressed phase. The concentrated samples can be sprayed onto superhydrophobic surfaces. For agricultural payloads, this can be leaves, flowers, and tree bark, for example. The spray-on sample stays on the plant surface in the single suppressed phase. The plant surface can then be washed with water to reduce the concentration of micelle/polymer complexes. This washing step dilutes the sample such that the total macromolecular concentration will be reduced and the formation of complex coacervates is induced. We have shown previously that the coacervates spread well on superhydrophobic surface, despite being water-based. Upon dilution, the coacervate, carrying the payload molecule, can spread efficiently across the plant surface. The ensures thorough and efficient spreading of payload molecules across the plant surface.

### Non-Limiting, Exemplary Imaging Studies Demonstrating Wetting Behavior of Dilution-Induced Release Compositions.

### Fluorescent Dye Encapsulation in Polymer-Surfactant Complex Coacervates.

Described herein is the encapsulation of hydrophobic and hydrophilic fluorescent dyes inside complex coacervates.

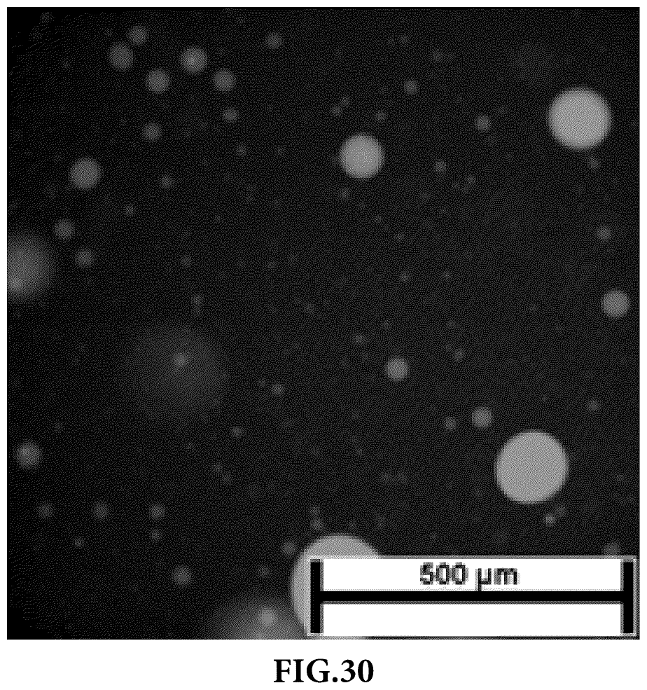

Nile Red is a highly hydrophobic, uncharged benzophenoxazone dye which exhibits strong fluorescence in hydrophobic environments. However, it is non-fluorescent in polar solvents. Nile red can diffuse into the hydrophobic micelle core. Therefore, this can be used to visualize hydrophobic domains of the coacervates. FIG. 30 shows that the coacevrate droplet is fluorescent, indicating the incorporation of the Nile Red into the micelles which then in turn becomes entrapped into the coacervate matrix.

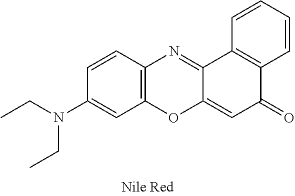 [SMILES: CCN(CC)c1ccc2nc3c4ccccc4c(=O)cc-3oc2c1]

Y=0.4 micelles were loaded with Nile red and it was mixed with 1.5 g/L PDADMAC to form coacervates. The coacervates were visualized under the fluorescence microscope.

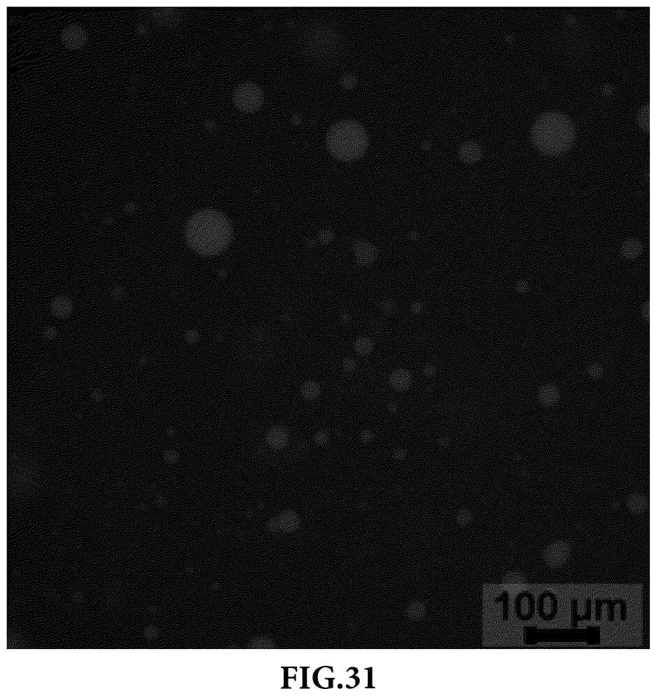

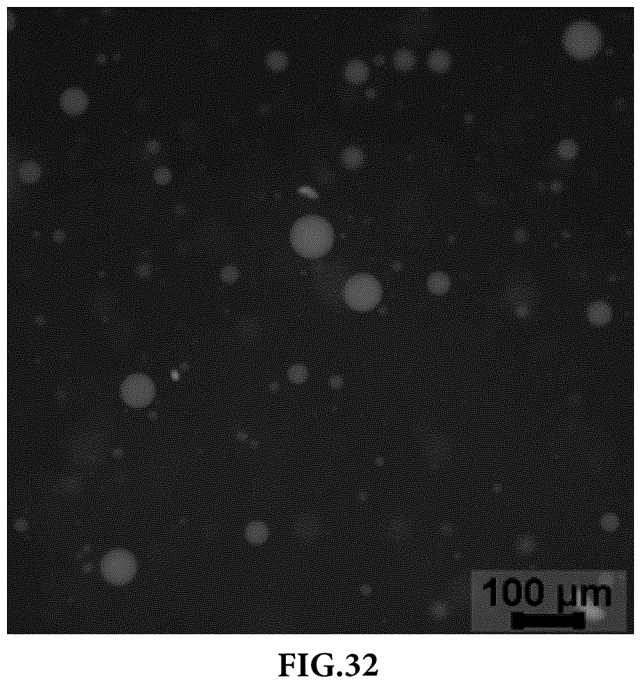

Rhodamine B has an excitation energy of 540-570 nm and an emission energy of 565-595 nm. Rhodamine B is a highly hydrophilic, cationic dye. This cationic dye can bind to SDS anionic micelles. FIG. 31 shows that the coacervate droplet is fluorescent, this is an indication of the encapsulation of Rhodamin B molecules. Without wishing to be bound by theory, this encapsulation is governed by the electrostatic interactions between the micelle and the dye. The below structure represents the Rhodamine B in it's zwitterionic state at a neutral pH. In an acidic environment the carboxyl group will become protonated lending more to the cationic nature of the dye molecule.

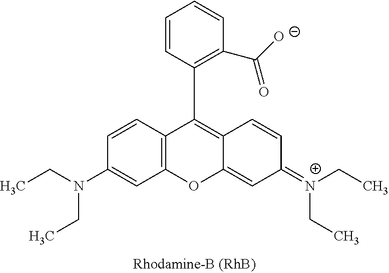 [SMILES: CCN(CC)c1ccc2c(-c3ccccc3C(=O)[O-])c3ccc(=[N+](CC)CC)cc-3oc2c1]

The cationic dye, Thioflavin-T (ThT) binds to the coacervates primarily through electrostatic interactions with anionic Sodium Dodecyl Sulfate (SDS) micelles and hydrophobic partitioning within the complex. This can restrict the rotation of ThT, leading to a dramatic increase in its quantum yield. In the presence of PDADMAC (a cationic polymer) the SDS-LA65N micelles forms a dense, condensed phase. The high local concentration of hydrophobic sites and anionic charge in the coacervate traps the ThT.

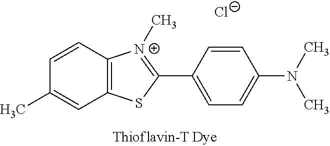

### Analogous Agrochemical Payloads

Without wishing to be bound by theory, the hydrophobicity or hydrophilicity, based on the partition coefficient (log P), of the dye molecules described herein can be used to determine the behavior of analogous agrochemical payloads. With similar encapsulation behavior as Thioflavin-T and Nile Red, pesticides such as Pyrethroid insecticides (e.g. Permethrin, Cypermethrin, and Deltamethrin), herbicides such as Atrazine, or fungicides such as triazole fungicide (e.g. Tebuconazole) or Azoxystrobin can be encapsulated withing the micellular fraction. Payloads with more hydrophilic nature similar to Rhodamine-B, such as herbicides like Paraquat and Diquat could also be encapsulated within the more hydrophobic phase of the coacervate system. Non-limiting examples of payload compounds and their physical properties are shown in Table 2. The log P values of the dyes are shown in comparison to the log P values of the agrochemical compounds.

TABLE 2
Non-Limiting, Exemplary Payloads

| | | | Expected | |
|---|---|---|---|---|
| | | Molecular | Micelle/ | |
| Payload | | Weight | Coacervate | |
| Compound | logP | (Da) | Location | Hydrophobicity |
| Thioflavin T | 3.02 | 318.86 | Corona → | Moderately |
| | | | shallow core | hydrophobic/ |
| | | | | amphiphilic |
| | | | | (cationic) |
| Nile Red | 3.65 | 318.38 | Core | Strongly |
| | | | | hydrophobic |
| RhodamineB | 1.9-2.0 | 479.02 | Corona/ | Amphiphilic → |
| | | | aqueous | hydrophilic |
| | | | adjacent | (open cation |
| | | | | form) |
| Permethrin | 6.1-6.5 | 391.29 | Core | Very strongly |
| | | | | hydrophobic |
| Cypermethrin | 6.22 | 416.30 | Core | Very strongly |
| | | | | hydrophobic |
| Deltamethrin | 6.20 | 505.20 | Core | Very strongly |
| | | | | hydrophobic |
| Tebuconazole | 3.7 | 307.82 | Corona → | Moderately- |
| | | | shallow core | strongly |
| | | | | hydrophobic |
| Azoxystrobin | 2.5-5.13 | 403.39 | Corona → | Moderate → |
| | | | core (range | strongly |
| | | | dependent) | hydrophobic |
| Atrazine | 2.59 | 215.69 | Corona/ | Moderately |
| | | | interface | hydrophobic |
| Paraquat | −4.5 | 257.16 | Aqueous/ | Strongly |
| | | | coacervate | hydrophilic |
| | | | (ionic) | (dicationic) |
| Diquat | −4.6 | 184.1- | Aqueous/ | Strongly |
| | | 186.25* | coacervate | hydrophilic |
| | | | (ionic) | (dicationic) |

### Non-Limiting Conclusions

The coacervate compositions described in this disclosure can be used to entrap hydrophobic molecules or charged hydrophilic molecules. Therefore, without wishing to be bound by theory, the coacervate compositions described herein can encapsulate hydrophobic pesticides, such as chlorpyrifos, dieldrin, and hexachlorobenzene, and cationic herbicides, such as paraquat and diquat. Accordingly, without wishing to be bound by theory, the coacervate compositions described herein can deliver the encapsulated payloads using methods (e.g., dilution) described herein.

### REFERENCES

Kumar S, Singh A K, Krishnamoorthy G, Swaminathan R. Thioflavin T displays enhanced fluorescence selectively inside anionic micelles and mammalian cells. J Fluoresc. 2008 November; 18 (6): 1199-205. doi: 10.1007/s10895-008-0378-2. Epub 2008 May 28. PMID: 18506603.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A dilution-induced release composition comprising:
a mixed surfactant micelle, wherein the mixed surfactant micelle comprises an anionic surfactant and a non-ionic surfactant in a mole fraction (Y) of about 0.20 to about 0.60;
a cationic polyelectrolyte;
a payload; and
an isoionic diluent.

2. The composition of claim 1, wherein:
the anionic surfactant is selected from one or more of an alkyl sulfate, an alkyl ether sulfate, an alkylbenzene sulfonate, or a sulfosuccinate;
the non-ionic surfactant is selected from one or more of a fatty alcohol ethoxylate, an alkylphenol ethoxylate, a fatty acid ethoxylate, or an alcohol alkoxylates; and
the payload is selected from a hydrophobic compound or a hydrophilic compound.

3. The composition of claim 2, wherein:
the hydrophobic compound comprises a fungicide, a pesticide, or an herbicide, wherein the partition coefficient (log P) is about 3.0 to about 7.0; and
the hydrophilic compound comprises a fungicide, a pesticide, or an herbicide, wherein the partition coefficient (log P) is about −4.5 to about 3.0.

4. The composition of claim 2, wherein:
the hydrophobic compound is selected from permethrin, cypermethrin, deltamethrin, tebuconazole, or azoxystrobin; and
the hydrophilic compound is selected from azoxystrobin, atrazine, paraquat, or diquat.

5. The composition of claim 2, wherein the alkyl sulfate is sodium dodecyl sulfate (SDS).

6. The composition of claim 2, wherein the fatty-alcohol ethoxylate is selected from one or more of:
lauryl myristyl alcohol ethoxylate of the formula: 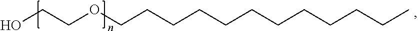
wherein n=6-7; or
octylphenol ethoxylate of the formula: 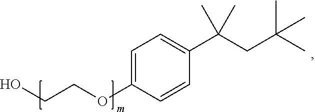
wherein m=9-10.

7. The composition of claim 1, wherein the cationic polyelectrolyte is selected from one or more of a poly(diallyldimethylammonium chloride) (PDADMAC), a poly(ethyleneimine) (PEI), a chitosan, a poly(allylamine), a poly(vinylamine), a poly(N-alkyl 4-vinyl pyridinium), a poly(N-alkyl 2-vinyl pyridinium), a poly([2-(acryloyloxy)ethyl]trimethylammonium), a poly(N,N-dimethyl-3,5-dimethylene piperidinium chloride), or a poly(vinylbenzyltrimethylammonium chloride) (PVBTMACl).

8. The composition of claim 7, wherein the cationic polyelectrolyte is poly(diallyldimethylammonium chloride) (PDADMAC) with an Mw of about 100 kDa to about 500 kDa.

9. The composition of claim 7, wherein the cationic polyelectrolyte is present in a concentration of about 0.5 mg/mL to about 30.0 mg/mL.

10. The composition of claim 1, wherein the iso-ionic diluent is a sodium chloride (NaCl) solution.

11. The composition of claim 10, wherein the NaCl solution is present in a concentration of about 300 mM to about 500 mM.

12. The composition of claim 1, wherein the composition is a coating, an adhesive, a surface modifier, an interfacial spreading mediator, a drug delivery system, or an anti-fouling agent.

13. The composition of claim 1, wherein:
the weight ratio of the cationic polyelectrolyte in relation to the total amount of mixed surfactant micelle (W) comprises about 0.10 to about 0.90;
the critical level total macromolecular concentration (Cₜ′) comprises about 10.0 mM to about 150 mM; and
the payload is present in a concentration of about 0.05 mM to about 10 mM.

14. The composition of claim 1, wherein the composition exhibits a contact angle of:
about 7° to about 25° on a hydrophilic surface; and
about 5° to about 25° on a hydrophobic surface.

15. The composition of claim 1, wherein
the anionic surfactant is sodium dodecyl sulfate present in about 1.5 mM to about 4.3 mM;
the non-ionic surfactant is lauryl myristyl alcohol ethoxylate present in about 4.0 mM to about 6.5 mM; and
the polycationic electrolyte is poly(diallyldimethylammonium chloride) (PDADMAC) present in about 1.25 mg/mL to about 3.25 mg/mL.

16. A method of forming a dilution-induced release composition, the method comprising:
providing a solution containing a cationic polyelectrolyte, a mixed surfactant micelle, and an iso-ionic diluent, wherein the cationic polyelectrolyte solution comprises a cationic polyelectrolyte dissolved in a solution, and wherein the mixed surfactant micelle comprises a non-ionic surfactant and an anionic surfactant in a molar fraction (Y) of about 0.05 to about 0.7; and
adding a payload compound to the solution, wherein the payload compound is selected from a hydrophobic compound or a hydrophilic compound, thereby forming a dilution-induced release composition.

17. The method of claim 16, wherein:
the non-ionic surfactant is selected from a fatty alcohol ethoxylate, alkylphenol ethoxylates, fatty acid ethoxylates, alcohol alkoxylates, or any combination thereof;
the anionic surfactant is selected from an alkyl sulfate, an alkyl ether sulfate, an alkylbenzene sulfonate, a sulfosuccinate, or a combination thereof;
the cationic polyelectrolyte is selected from poly(diallyldimethylammonium chloride) (PDADMAC), poly(ethyleneimine) (PEI), a chitosan, poly(allylamine), poly(vinylamine), poly(N-alkyl 4-vinyl pyridinium), poly(N-alkyl 2-vinyl pyridinium), poly([2-(Acryloyloxy)ethyl]trimethylammonium), Poly(N,N-dimethyl-3,5-dimethylene piperidinium chloride), poly(vinylbenzyltrimethylammonium chloride) (PVBTMACl), or a combination thereof;
the hydrophobic payload compound comprises a fungicide, a pesticide, or an herbicide, wherein the partition coefficient (log P) is about 3.0 to about 7.0;
the hydrophilic payload compound comprises a fungicide, a pesticide, or an herbicide, wherein the partition coefficient (log P) is about −4.5 to about 3.0; and
the iso-ionic diluent comprises a sodium chloride (NaCl) solution.

18. The method of claim 17, wherein:
the cationic polyelectrolyte and total amount of surfactant comprise a weight ratio (W) of about 0.01 to about 0.90;
the critical level total macromolecular concentration (Cₜ′) comprises about 1.0 mM to about 150 mM; and
the iso-ionic diluent is present in a concentration of about 100 mM to about 700 mM.

19. A method of delivering a payload to a surface, the method comprising;
administering a dilution-induced release composition comprising a payload to a surface, wherein the dilution-induced release composition comprises the composition of any one of claims 1-15; and
applying a diluent to the dilution-induced release composition comprising a payload, thereby delivering a payload to a surface.

20. The method of claim 19, wherein:
the administering comprises spraying, layer-by-layer self-assembly, drop casting, spread coating, or a combination thereof;
the applying a diluent comprises diluting the dilution-induced release composition comprising a payload until the critical total macromolecular concentration (C_{T}′) is reached;
the surface of interest comprises a superhydrophobic plant leaf, a rough hydrophobic surface, a plant bark surface, a textile, a printing surface, or a microfluidic device surface; and
the diluent comprises an aqueous liquid.
